(19) United States
(12) Patent Application Publication
(10) Pub. No.: US 2023/0061175 A1
(43) Pub. Date: Mar. 2, 2023

(54) Real-Time Simulation of Elastic Body

(71) Applicant: Mimyk Medical Simulations Private Limited, Bangaluru (IN)

(72) Inventors: Nithin SHIVASHANKAR, Bengaluru (IN); Shanthanu CHAKRAVARTHY, Bengaluru (IN); Varun SESHADRINATHAN, Bengaluru (IN); S Raghu MENON, Bengaluru (IN)

(73) Assignee: Mimyk Medical Simulations Private Limited, Bangaluru (IN)

(21) Appl. No.: 17/981,809

(22) Filed: Nov. 7, 2022

Related U.S. Application Data
(63) Continuation-in-part of application No. PCT/IN2021/050051, filed on Jan. 19, 2021.

(30) Foreign Application Priority Data
May 7, 2020 (IN) 202041019454

(51) Int. Cl. G06F 30/25; G06F 30/10

(52) U.S. Cl. CPC G06F 30/25; G06F 30/10

(57) ABSTRACT

An elastic body is modelled as a plurality of models of particles and models of geometric elements. Each particle model has a position attribute. Each geometric element has a boundary defined by two or more of the particles as nodes of the geometric element, nodes being points shared with neighbouring geometric elements. The interior area or volume of the geometric elements is modelled via non-linear interpolation functions that use the positions of the particles of the respective geometric elements as inputs to compute position and/or strain of interior points of the geometric elements. Energy is summed over the interior region of the element, the energy computation based on (a) position and/or stress of the geometric element computed by the non-linear interpolation functions and/or (b) non-linear material parameters that depend on position and/or strain at the interior points of the geometric elements. New positions of the particles are computed based minimizing total energy of the element.

### BACKGROUND

This application is a continuation-in-part of International Application PCT/IN2021/050052, filed Jan. 19, 2021, which claims priority from India Application 202041019454 filed May 7, 2020, each incorporated by reference.

Rigid body simulations have become common place over the past several decades. Simulating elastic bodies has been an emerging trend in the real-time simulation setting, such as the dynamics of rigid bodies, clothing, deformable objects or fluid flow. Several methods for simulation of dynamics of elastic bodies have been proposed. One of the major challenges in simulating elastic bodies is the difficulty in obtaining realistic, high-fidelity solutions in real-time. One conventional approach has been to simulate dynamic objects by computing forces acting on an object over time steps. At the beginning of each time step, internal and external forces are accumulated. Examples of internal forces are elastic forces in deformable objects or viscosity and pressure forces in fluids. Gravity and collision are examples of external forces. It is well known that Newton’s second law of motion relates forces to accelerations via the mass. Using the density or lumped masses of vertices, the forces can then be transformed into acceleration values. Subsequently, any time integration scheme can be used to first compute the velocities from the accelerations and then the positions from the velocities. There are other known methods which alternatively use impulses instead of forces to control the simulation. Such methods involve directly manipulating velocities, such that one layer of integration can be skipped.

Another popular approach for simulating dynamic objects involves using position-based dynamics (PBD). A position based approach eliminates the velocity layer and immediately works on the positions. In computer graphics and especially in computer games, it is often desirable to have direct control over positions of objects or vertices of a mesh. The user may want to attach a vertex to a kinematic object or ensure the vertex always stay outside a colliding object. In such cases, it is beneficial to have an approach that works directly on the positions of objects, which makes such manipulations more efficient. In addition, with the position based approach it is possible to control the integration directly, thereby, avoiding overshooting and energy gain problems in connection with explicit integration. In position based methods, general constraints are defined via a constraint function. These methods involve directly solving for the equilibrium configuration and project positions.

Position-Based Dynamics (PBD) is a popular method for the real-time simulation of deformable bodies in games and interactive applications. PDB is a method used to simulate physical phenomena like cloth, deformation, fluids, fractures, rigidness and much more. The method is particularly attractive for its simplicity and robustness, and has recently found popularity outside of games, in film and medical simulation applications. The key process in PBD is to simulate the object as a set of points and constraints. Constraints are kinematic restrictions in the form of equations and inequalities that constrain (e.g., restrict) the relative motion of bodies. Forces are applied to the points to move them, and the constraints ensure that the points will not move in a way that violates the rules of the simulation. Position based simulation gives control over explicit integration and removes the typical instability problems.

These traditional methods based on Finite Element Methods (FEM), while being accurate, very often do not provide solutions in real time. The more modern position-based or constraint-based dynamics approaches seek to address this problem by delivering real time solutions, but these are not always realistic and generally fail in conditions of large deformations where non-linear effects can no longer be ignored. One well known limitation is that PBD’s behaviour is dependent on the time step and iteration count of the simulation. Specifically, constraints become arbitrarily stiff as the iteration count increases, or as the time step decreases. This coupling of parameters is particularly problematic when creating scenes with a variety of material types, e.g. soft bodies interacting with nearly rigid bodies.

Therefore, in light of the foregoing discussion, there exists a need to overcome problems associated with conventional systems and methods for simulation of the dynamics of an elastic body, where the body is represented by finite elements.

### SUMMARY

The present disclosure solves the problem of real-time simulation of the dynamics of an elastic body, where the body is represented by three dimensional finite elements. The present disclosure proposes analytic equations and algorithms for solving three-dimensional (3D) finite elements for a position-based dynamics method known as XPBD. This allows for the efficient real-time simulation of elastic bodies, such as human tissues, soft toys, thick cloth surfaces.

In general, in a first aspect, the invention features a method. In the memory of a computer is stored a model of an elastic body as a plurality of models of particles and models of geometric elements. Each particle model has a position attribute. Each geometric element has a boundary defined by two or more of the particles as nodes of the geometric element, nodes being points shared with neighbouring geometric elements. The computer models the interior area or volume of the geometric elements with non-linear interpolation functions that use the positions of the particles of the respective geometric elements as inputs to compute position and/or strain of interior points of the geometric elements. The processor computes an energy summed on the interior region of the element, the energy computation based on (a) position and/or stress of the geometric element computed by the non-linear interpolation functions and/or (b) non-linear material parameters that depend on position and/or strain at the interior points of the geometric elements. The processor computes new positions of the particles based on a computation to minimize total energy of the element.

Specific embodiments may incorporate one or more of the following features. A display of the modelled elastic body may be computed based on the computed new positions of the particles. A control value may be computed to be delivered to a haptic actuator of a physical apparatus instantiating the modelled elastic body, the computation based on the computed new positions of the particles and/or the stresses and/or the strains at the nodes and/or the interior points of one or more of geometric elements. The physical apparatus may be a medical simulator, robotic device, or human computer interaction (HCI) device. The elastic body may be an article under design or evaluation by a computer aided design (CAD) tool and/or computer aided design and/or engineering (CAD/E) tool. The elastic body is an article may be a game, virtual reality world, or animation world. Modelled objects may be displayed on a display in real time. The computation may balance kinetic energy introduced into a corresponding geometric element against potential energy contained within stresses among the plurality of particles in the geometric element. The energy computation may be based on position and/or bending of the geometric element computed by the non-linear interpolation functions. The energy computation may be based on non-linear material parameters that depend on position and/or strain at the interior points of the geometric elements. The energy computation may be based on both (a) position and/or bending of the geometric element computed by the non-linear interpolation functions, and (b) non-linear material parameters that depend on position and/or bending at the interior points of the geometric elements. Some of the geometric elements may be modelled by an energy computation based on linear interpolation functions for position and/or strain. Some of the geometric elements may be linear tetrahedra, some may be quadratic tetrahedral. Some may be cubic tetrahedra. Some of the geometric elements may be tetrahedra, some triangular prisms, and some hexahedra. The computation may be divided among cores of a processor for parallel computation.

In particular, the simulations are performed on models that consist of 3D finite elements extended over a surface. The models are then subject to the different constraints that govern their dynamics. The contribution in this work is the application of principles of finite element method in the XPBD framework, which involves novel definitions of finite element method (FEM) based constraint functions, to realistically simulate elastic body deformations. The presently disclosed method is easily extendible to incorporate non-linear, quadratic tetrahedron elements to provide FEM implementation of a non-linear element in a real-time setting.

In an aspect, a method for real-time simulation of an elastic body comprising a plurality of particles is provided. The method comprises modelling the elastic body as a plurality of geometric elements with one or more predefined geometries, each of the plurality of geometric elements having three or more particles among the plurality of particles as nodes for the one or more predefined geometries thereof. The method further comprises defining a single constraint function indicative of strain energy for each of the geometric elements. The method further comprises computing a gradient of the single constraint function to determine a direction of force on each of the geometric elements. The method further comprises determining a deformation at the nodes of each of the geometric elements along the determined direction of force. The method further comprises interpolating the determined deformation at the nodes of each of the geometric elements to the respective entire geometric element.

In one or more embodiments, the deformation at a given node of each of the geometric elements is determined by: defining a first position for a particle, among the plurality of particles, at the given node; computing a second position after a time step by resolving forces acting on the particle, among the plurality of particles, at the given node; and calculating the deformation for the particle, among the plurality of particles, at the given node as the difference between the first position and the second position thereof.

In one or more embodiments, resolving forces acting on the particle, among the plurality of particles, at the given node comprises balancing kinetic energy introduced into a corresponding geometric element against potential energy contained within stresses among the plurality of particles in the geometric element.

In one or more embodiments, each of the geometric elements is at least one of a linear finite element and a non-linear finite element.

In one or more embodiments, each of the geometric elements is in the shape of one of triangle, square, rectangle, cube, cuboid, tetrahedron and hexahedron.

The constraint function (Cₑ(U)) for each of the geometric elements may be given by:

$${C}_{e} ( U ) = \sqrt{{U}^{T} {K}_{e} U}$$

wherein ‘U’ is the deformation at all nodes of a given element, and ‘Kₑ’ is the stiffness matrix computed over the corresponding entire geometric element and is given as:

$${K}_{e} = \int {B}^{T} Σ B d v$$

wherein ‘B’ is the matrix that relates strains on the corresponding entire geometric element to the deformation at the given node and ∑ is the standard 6 × 6 constitutive matrix that relates deformation strains with stress forces.

The gradient of the single constraint function (∇Cₑ(U)) may be computed as:

$$∇ {C}_{e} ( U ) = \frac{{U}^{T} {K}_{e}}{{C}_{e} ( U )}$$

wherein ‘Kₑ’ is the stiffness matrix and is an integral that is computed over volume of the corresponding entire geometric element.

In one or more embodiments, the method for real-time simulation of an elastic body is implemented in a haptic device for near real-time medical simulation.

In another aspect, a system for real-time simulation of an elastic body comprising a plurality of particles is provided. The system comprises a processing unit and a memory device coupled to the processing unit, the memory device having instructions stored thereon that, in response to execution by the processing unit, cause the processing unit to perform operations comprising: modelling the elastic body as a plurality of geometric elements with one or more predefined geometries, each of the geometric elements having three or more particles among the plurality of particles as nodes for the one or more predefined geometries thereof; defining a single constraint function indicative of strain energy for each of the geometric elements; computing a gradient of the single constraint function to determine a direction of force on each of the geometric elements; determining a deformation at the nodes of each of the geometric elements along the determined direction of force; and interpolating the determined deformation at the nodes of each of the geometric elements to the respective entire geometric element.

In one or more embodiments, the deformation at a given node of each of the geometric elements is determined by: defining a first position for a particle, among the plurality of particles, at the given node; computing a second position after a time step by resolving forces acting on the particle, among the plurality of particles, at the given node; and calculating the deformation for the particle, among the plurality of particles, at the given node as the difference between the first position and the second position thereof.

In one or more embodiments, resolving forces acting on the particle, among the plurality of particles, at the given node comprises balancing kinetic energy introduced into a corresponding geometric element against potential energy contained within stresses among the plurality of particles in the geometric element.

In one or more embodiments, the processing unit is a multi-thread processor, and wherein the deformation at the nodes of each of the geometric elements are computed in parallel, with each deformation being computer discretely at one of threads of the multi-thread processor.

In one or more embodiments, the memory is further configured to store data generated for simulation of the elastic body to be used as one or more of for training a neural network and to be utilized by a neural network for enhancing simulation of elastic bodies

In one or more embodiments, the system further comprises: a database containing information about geometry of the elastic body; and a sensor configured to detect and measure force of collision of an external object with the elastic body. Herein, the processing unit is configured to define the single constraint function for each of the geometric elements of the elastic body based on the information about geometry of the elastic body and the said measured force.

In yet another aspect, a computer program product comprising at least one non-transitory computer-readable storage medium having computer-executable program code instructions stored therein is provided. The computer-executable program code instructions comprise program code instructions to: model the elastic body as a plurality of geometric elements with one or more predefined geometries, each of the geometric elements having three or more particles among the plurality of particles as nodes for the one or more predefined geometries thereof; define a single constraint function indicative of strain energy for each of the geometric elements; compute a gradient of the single constraint function to determine a direction of force on each of the geometric elements; determine a deformation at the nodes of each of the geometric elements along the determined direction of force; and interpolate the determined deformation at the nodes of each of the geometric elements to the respective entire geometric element.

In one or more embodiments, the deformation at a given node of each of the geometric elements is determined by: defining a first position for a particle, among the plurality of particles, at the given node; computing a second position after a time step by resolving forces acting on the particle, among the plurality of particles, at the given node; and calculating the deformation for the particle, among the plurality of particles, at the given node as the difference between the first position and the second position thereof.

The foregoing summary is illustrative only and is not intended to be in any way limiting. In addition to the illustrative aspects, embodiments, and features described above, further aspects, embodiments, and features will become apparent by reference to the drawings and the following detailed description.

### DESCRIPTION OF THE DRAWINGS

For a more complete understanding of example embodiments of the present disclosure, reference is now made to the following descriptions taken in connection with the accompanying drawings in which:

FIG. 1 illustrates a system that may reside on and may be executed by a computer, which may be connected to a network;

FIG. 2 illustrates a diagrammatic view of a server device;

FIG. 3 illustrates a diagrammatic view of a client device;

FIG. 4 illustrates a flowchart depicting steps involved in a method for real-time simulation of an elastic body;

FIGS. 5A-5D illustrate exemplary geometric elements for implementing proposed framework; and

FIG. 6 illustrates a block diagram of a haptic system implementing proposed framework.

### DESCRIPTION

The Description is organized as follows.
I. Overview
   I.A. General Discussion
   I.B. FEM constraint function with XPBD
II. Modeling
   II.A. Meshing and Model Representation
   II.B. Linear elastic model
   II.C. Linear tetrahedral elements
   II.D. Quadratic tetrahedral element
III. FEM-XPBD Computation
   III.A. Quadratic tetrahedrons
   III.B. Time stepping
IV. Haptics
V. Combining techniques from other modelling frameworks
VI. Embodiments
VII. Definitions and computer implementation

### I. Overview

In the following description, for purposes of explanation, numerous specific details are set forth in order to provide a thorough understanding of the present disclosure. It will be apparent, however, to one skilled in the art that the present disclosure is not limited to these specific details.

Real-time behaviour of an elastic body may be simulated. The elastic body can be construed to be comprising a plurality of particles for the purposes of the present disclosure. In the present disclosure, similar terms are to be associated with the appropriate physical quantities and are merely convenient labels applied to these quantities. Unless specifically stated otherwise as apparent from the following discussions, terms such as "modelling," "estimating," “determining,” “scaling,” “solving,” “adjusting,” “predicting,” “finding,” “updating,” and “applying,” “identifying,” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

### I.A. General Discussion

One of the standard approaches to physics-based simulation of soft or deformable bodies, is to model the object(s) that undergoes change, as a spring-mass-damper system. Mathematically, from Newton’s second law, this is represented as:

$$M \ddot{x} + C \dot{x} + K x = 0$$

The first term Mẍ is representative of the net external force that acts on the entity(s), which comes from the Newton’s second law, namely the rate of change of momentum on an object is equal to the net external force acting on it. This external force can be due to damping/friction, the elastic surface forces, such as the recoil of a spring or the body forces that act throughout volume of the object. In the above eq. 1, for simplicity, only damping and the surface forces are considered. The second term in the above eq. 1, accounts for forces exerted due to interactions such as friction and drag/viscosity. The third term Kx, which represents the elastic effects of a spring, accounts for forces that are intrinsic such as stress forces that cause strains. Herein, x denotes the position(s) of the entity(s) being simulated, and ẋ and ẍ denote the first and second time derivative of ‘x’ which are the respective velocity and acceleration experienced by the entity(s).

Several techniques have emerged from the computer graphics requirements of real time simulation. Three techniques are of relevance for real time simulation of elastic bodies, namely position-based dynamics (PBD), extended position-based dynamics (XPBD), and projective dynamics (PD). These three techniques are fundamentally based on a principle of energy minimization and hence solve the general equations of motion from an optimization viewpoint, where the elasticity of bodies is viewed as constraints in an optimization problem.

These three techniques have some properties in common. Entities are modelled as a collection of particles, whose positions are denoted by X. These particles have an associated velocity V. X and V are column vector containing the 3D positions and velocities of all particles sequentially. If there are N particles in the system, then X and V would be 3 N × 1 matrices. Herein, the coordinates of the i^{th} particle is denoted by xᵢ· The simulation discretely moves forward in time with a time step of h. Before stepping forward in time, the position Xₙ and velocity Vₙof the particle is known. When this step is taken, the positions are adjusted by resolving all forces acting on each particle to determine the new (and unknown) positions Xₙ₊₁ and velocities V_{n+1·}

The following is a basic framework for a constraint-based formulation for the solution of the spring-mass-damper model:

$${V}_{p} = {V}_{v 8} + h {M}^{- 1} {f}_{e x t}$$

$${\text{X}}_{p} = {X}_{n} + h {V}_{P}$$

$${X}_{n + 1 = arg {min}_{X n + 1}} \frac{1}{2 {h}^{2}} M ∥ {X}_{n + 1} - {X}_{p} {∥}_{F}^{2} + E ( {X}_{n + 1} )$$

$${V}_{n + 1} = ( {X}_{n + 1} - {X}_{n} ) / h$$

Steps 1 and 2 correspond to direct integration of positions and velocities of the particles of the modelled entity. These are the predicted positions at which the particles would have been if there were no interaction between particles. Formula steps 1, 2 and 4 are straightforward as the values on left-hand side (LHS) may be explicitly computed using the expressions on right-hand side (RHS). The key step of position dynamics and projective dynamics is in the evaluation of the value of Xₙ₊₁ in formula step 3. This is challenging as Xₙ₊₁ appears on both the LHS and RHS of formula step 3, as may be seen above. The term Xₙ₊₁ in formula step 3 represents the equilibrium position of the particles that balance the external forces and internal forces, whereas Xₚ represents the updated position purely due to external forces. Also, the first term in formula step 3 expresses the net kinetic energy added to the system by moving from Xₚ to X_{n+1·} The second term in formula step 3 depends on the expression of the energies due to internal stresses, collisions, and other forms of energy intrinsic to the particles of the system. To obtain this equilibrium position, the total energy of the system needs to be balanced. To this end, the kinetic energy introduced into the system (due to relieving internal stresses) is balanced against the potential energy contained within the stresses themselves.

In Position-based Dynamics (PBD) framework, which is a popular position integration method, energy is defined to originate from the violation of a set of constraint functions ∑ᵢCᵢ(Xₚ + ΔX). In terms of the framework discussed previously, PBD ignores the first term in RHS of formula step 3. In other words, given the predicted position Xₚ, it requires to seek a correction ΔX so that:

$$E ( {X}_{p} + Δ X ) = {\sum }_{j} {C}_{j} ( {X}_{p} + Δ {X}_{j} ) = 0$$

Considering each constraint individually, they seek a correction AX_{ï} using a first order approximation near Xₚ, that is

$${C}_{j} ( {X}_{p} + Δ {X}_{i} ) \approx {C}_{j} ( {X}_{p} ) + ∇ {C}_{j} ( {X}_{p} ) . Δ {X}_{j} = 0$$

Next, the PBD framework assumes that the solution to ΔXᵢ for this constraint must align with constraint gradient with weights on each particle defined by the inverse mass matrix, that is

$$Δ {X}_{j} = {λ}_{j} {M}^{- 1} ∇ {C}_{j} {( {X}_{P} )}^{T}$$

Plugging this back into the previous equation, it is derived that

$${λ}_{j} = - \frac{{C}_{j} ( {X}_{P} )}{∇ {C}_{j} ( {X}_{P} ) . {M}^{- 1} ∇ {C}_{j} {( {X}_{P} )}^{T}}$$

Plugging this back again to the previous equation, ΔXᵢ is computed for each constraint. The total correction for all constraints is computed as the sum of the individual constraint corrections.

$$Δ X = {\sum }_{j} Δ {X}_{j}$$

From an implementation point of view, the PBD framework is scalable for GPUs, as each constraint usually involves a small number of particles. Hence the computation of ΔXᵢ for each constraint can be easily parallelized and then combined to obtain ΔX. However, the PBD framework makes a crucial assumption that after every prediction, the entire energy of these constraints should be eliminated as quickly as possible. This does not balance out the extra kinetic energy being introduced due to position correction. In other words, the correction term ΔX introduces unaccounted energy into the simulation. This results in non-physical behaviour. For instance, a simple spring constraint between two particles will be solved in one iteration, wherein the equilibrium will be reached in a time span of h. Regardless of the value of h, the spring will snap into its rest length. Therefore, the PBD framework suffers from the problem of converging to an infinitely stiff solution, which comes from the formulation itself. That is, in the assumption of infinite stiffness, formula step 3 becomes a constrained minimization problem that PBD solves approximately. In other words, PBD updates the particle’s position by introducing a constraint stiffness as a multiplier on each constraint correction. This effective constraint stiffness is dependent on both the time step and the number of constraint projections performed. Exponentially scaling the stiffness, addresses this problem but introduces the problem of convergence to a stiff solution.

To solve the above problem, XPBD framework has been devised which is an extension of the PBD framework that seeks to correct this problem of stiff solution convergence by introducing compliant based constraints. This extension allows the energy term to be regularized and the compliance thus introduced has a direct relationship to the Young’s modulus or stiffness. As understood, from Newton’s second law, it is known that

$$M \ddot{x} = ∇ E ( x )$$

where, E is the energy term and is defined based on constraints,

$$E ( x ) - \frac{1}{2} C ( x ) {a}^{- 1} C ( x )$$

with α being defined as the compliance, which is the inverse of the stiffness, i.e., α = k⁻¹. The force given by this compliance is then given by the negative gradient of the energy potential, i.e.,

$$f = - ∇ E ( x )$$

$$f = - ∇ {C}^{T} {a}^{- 1} C$$

The XPBD frame proposes to decompose this force into its components by using a Lagrange multiplier, given by,

$$λ = - {\tilde{a}}^{- 1} C ( x )$$

where,

$$\tilde{a} = \frac{a}{\tilde{h} 2}$$

Here

$$\tilde{a}$$

is the compliance adjusted with the time step. Substituting this in the equation of motion, and linearizing the resulting equations, solution for Δλ and Δx can be obtained as:

$$( ∇ {C}_{i} {M}^{- 1} ∇ {C}_{i}^{T} + \tilde{a} ) Δ λ = - C - \tilde{a} {λ}_{i}$$

$$Δ x = {M}^{- 1} ∇ {C}^{T} Δ λ$$

The XPBD framework provides updating of both the Lagrange multipliers and the positions, which is similar to the implementation of PBD framework. The first step is to update λ based on a constraint solution with the following expression,

$$Δ {λ}_{i} = \frac{- {C}_{i} - {\tilde{α}}_{i} {λ}_{i j}}{∇ {C}_{i} {M}^{- 1} ∇ {C}_{i}^{T} + {\tilde{α}}_{i}}$$

Here λᵤ is the refers to the total Lagrange multiplier of constraint i at iteration j. The updates to λ and x are then performed as

$${λ}_{i \text{+1}} = λ + Δ λ$$

$${x}_{i + 1} = x + Δ x$$

Herein, the Lagrange multiplier is stored in addition to the positions for every iteration.

One of the major advantages of the XPBD framework is the ability to incorporate energy potentials in the form of compliance constraints, thereby providing more physically accurate and realistic solutions than PBD framework while retaining its flexibility. The XPBD framework, by the time-step adjusted compliance matrix

$$\tilde{α} ,$$

relates the change in kinetic energy due to change in the predicted position of the particles back to internal energy of the constraint. For instance, a spring is the simplest entity in the modeling of stresses/strains and energies of mechanical systems. A spring is a constraint between two particles and is parametrized by its rest length L and its spring constant K. In an example, assuming a system with two particles in 3D space with X = [x₀_{,}x₁], the energy due to the spring in the system is given by:

$$E \left(X\right) = \frac{1}{2} \times K \times {\left(\left|{x}_{1} - {x}_{0}\right| - L\right)}^{2}$$

### I.B. FEM Constraint Function With XPBD

FEM (Finite Element Model) based constraint functions may be used in the XPBD simulation framework. In particular, a connection is established between FEM forces and energies with the constraint formulations of XPBD simulation framework. The system (such as, the system 100 and/or systems 200 and 300) of the present disclosure implements the FEM constraint function with XPBD (as described above) for real-time simulation of an elastic body, where the elastic body is construed to have a plurality of particles. Such system including a processing unit (such as, the processing unit 205 and 305) and a memory device (such as, the memory 210), with the memory device coupled to the processing unit, and the memory device having instructions stored thereon that, in response to execution by the processing unit, causes the processing unit to perform operations related to the real-time simulation of the elastic body.

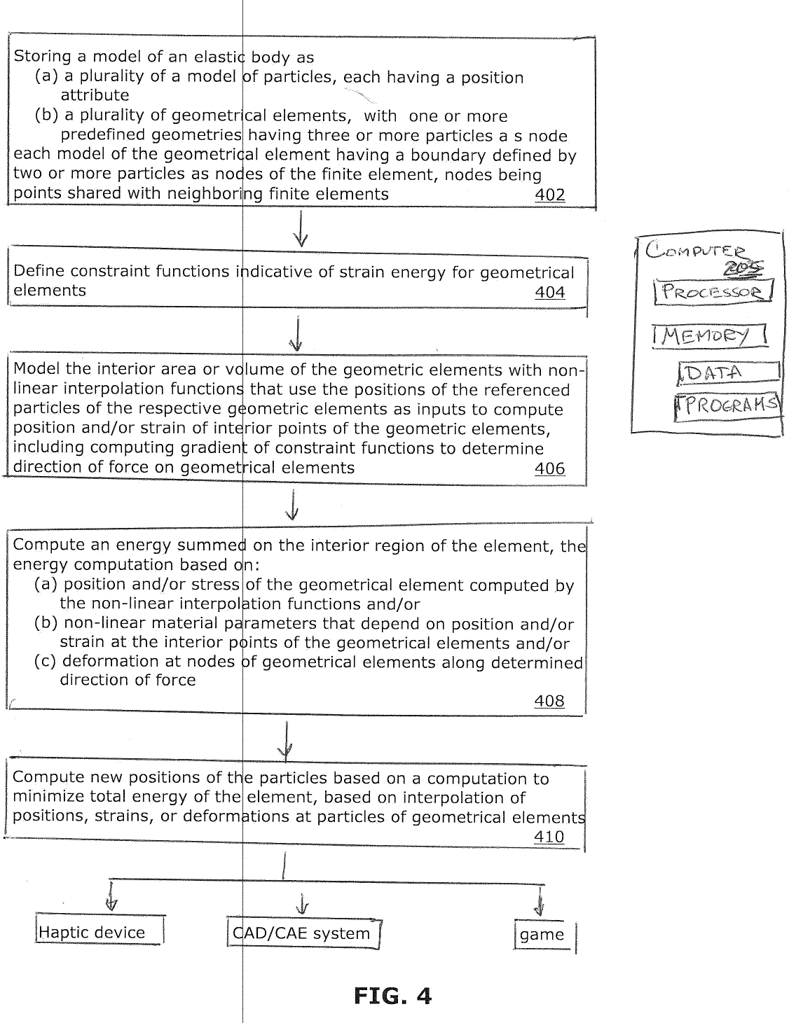

Referring to FIG. 4, illustrated is a flowchart 400 listing steps involved in a method for real-time simulation of an elastic body comprising a plurality of particles. Steps of the given method would be performed by the processing unit (such as, the CPU 205 and/or 305) of the system (such as, the system 100 including the computing device 200 and/or 300). Although steps and sequencing of the method are disclosed in figures (e.g. FIG. 4) herein describing the operations of this method, such steps and sequencing are exemplary.

Herein, at step 402, the method includes modelling of the elastic body as a plurality of geometric elements with one or more predefined geometries, each of the geometric elements having three or more particles among the plurality of particles as nodes for the one or more predefined geometries thereof. Finite element theory provides a basic framework for formulating stresses and strains formed in an object with known geometry and material composition. The object is typically modeled as a set of particles (also known as nodes) and elements which define the geometry of the object. Each of the geometric elements is at least one of a linear finite element and a non-linear finite element. The elements are usually simple shapes such as triangles, squares, and rectangles in 2D. In 3D, they are usually tetrahedrons, cubes, cuboids or hexahedra. Each of the geometric elements may be in the shape of one of triangle, square, rectangle, cube, cuboid, tetrahedron and hexahedron.

### II. Modelling

### II.A. Meshing and Model Representation

Specifically, the material surface is modelled as a set of points connected by triangles and this set collectively is called a mesh. This mesh is modelled in standard surface modelling software (such as Blender® or Maya®). Meshes from such software usually have noncontinuous curvature along edges where triangles meet. Other software (such as Catia®) allow modelling of meshes with continuous curvature. These two types of meshes, discontinuous curvature and continuous curvature meshes, are further respectively developed into sets of linear and quadratic tetrahedral elements. As discussed, to form a surface with thickness, points from the mesh are extruded along the normal direction of the surface they represent. One may visualize each triangle being extruded into a prism like object. Each prism like object can be broken into 3 tetrahedral elements. These make up the respective FEM linear and quadratic tetrahedral elements. Herein, the tetrahedral elements hold the stiffness parameters relevant to the material, such as Young’s modulus and Poisson ratio. These elements can be extended to more layers depending on the nature of the material simulated.

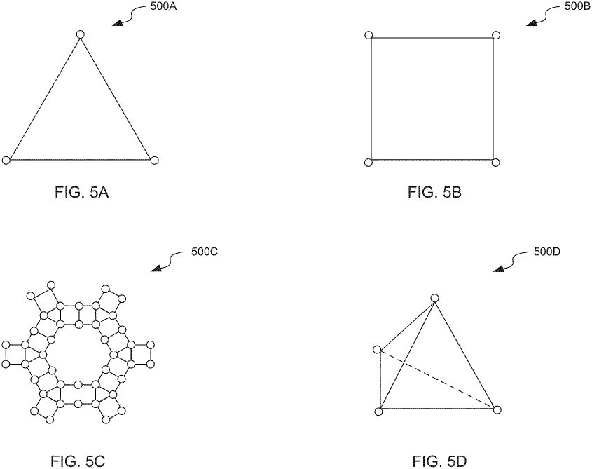

FIGS. 5A-5D illustrate exemplary geometric elements to be used in FEM analysis of the elastic body. In particular, FIG. 5A illustrates a geometric element with triangular geometry, FIG. 5B illustrates a geometric element with square geometry, FIG. 5C illustrates a geometric element with hexagonal gear model geometry, and FIG. 5D illustrates a geometric element with 3D finite tetrahedral geometry. Herein, the points in the geometric elements represents nodes therein. Nodes are shared between elements. Geometric elements relate with continuous physical material properties via the finite element model (FEM). Hooke’s law states that the stress experienced (being the force per unit area) by a material is proportional to the strain (being the deformation in the body) it experiences, up-to an upper limit in stress after which this relation does not hold.

At step 404, the method includes defining a single constraint function indicative of strain energy for each of the geometric elements. As discussed in the preceding paragraphs, the single constraint function (Cᵢ(U)) for each of the geometric elements is given by:

$${C}_{e} \left(U\right) = \sqrt{{U}^{T} {K}_{e} U}$$

wherein ‘U’ is the deformation at a given node, and ‘Kₑ’ is the stiffness matrix computed over the corresponding entire geometric element and is given as:

$${K}_{e} = \int {B}^{T} Σ B d v$$

wherein ‘B’ is the matrix that relates strains on the corresponding entire geometric element to the deformation at the given node and ∑ is the standard 6 × 6 constitutive matrix that relates deformation strains with stress forces.

Further, as discussed, the gradient of the single constraint function (∇Cᵢ(U)) is computed as:

$$∇ {C}_{e} \left(U\right) = \frac{{U}^{T} {K}_{e}}{{C}_{e} \left(U\right)}$$

wherein ‘K’ is the stiffness matrix and is an integral that is computed over volume of the corresponding entire geometric element.

### II.B. Linear Elastic Model

In the linear elastic model, the standard definition of strain ε is the rate of change of the deformation along the principal axes, which is given as:

$$ε = \left[\begin{matrix}{ε}_{\text{x}} \\ {ε}_{\text{y}} \\ {ε}_{\text{z}} \\ {ε}_{\text{xy}} \\ {ε}_{\text{yz}} \\ {ε}_{\text{zx}}\end{matrix}\right] \left[\begin{matrix}\frac{\partial {\text{u}}_{\text{x}}}{\partial \text{x}} \\ \frac{\partial {\text{u}}_{\text{y}}}{\partial \text{y}} \\ \frac{\partial {\text{u}}_{\text{z}}}{{\partial }_{\text{z}}} \\ \frac{\partial {u}_{\text{x}}}{\partial \text{y}} + \frac{\partial {u}_{\text{y}}}{\partial \text{x}} \\ \frac{\partial {\text{u}}_{\text{y}}}{\partial \text{z}} + \frac{\partial {\text{u}}_{\text{z}}}{\partial \text{y}} \\ \frac{\partial {\text{u}}_{\text{z}}}{\partial \text{x}} + \frac{\partial {\text{u}}_{\text{x}}}{\partial \text{z}}\end{matrix}\right]$$

The first three terms, εₓ, ε_{y}, ε_{z}, are due to stretching and compression along the principal axes, and the last three terms, ε_{xy}, ε_{yz}, ε_{zx}, are shearing strains on planes (referenced by the subscripts). Herein, the quantities u_{x,} u_{y}, u_{z}, represent the deformation of the body. Further, herein, the stress σ being experienced at a point is converted to a stress (force/unit area) via a standard 6x6 constitutive matrix ∑. The elements of this matrix are written using two standard constants.; namely, the Young’s modulus (Y) and the Poisson ratio (v), whose values are well known for most engineering materials such as steel, etc. Given the Young’s modulus and the Poisson ratio, the constitutive matrix is given as

$$Σ = \frac{Y}{\left(1 + v\right) \left(1 - 2 v\right)} \left[\begin{matrix}1 - v & v & v & 0 & 0 & 0 \\ v & 1 - v & v & 0 & 0 & 0 \\ v & v & 1 - v & 0 & 0 & 0 \\ 0 & 0 & 0 & \frac{1}{2} - v & v & 0 \\ 0 & 0 & 0 & 0 & \frac{1}{2} - v & 0 \\ 0 & 0 & 0 & 0 & 0 & \frac{1}{2} - v\end{matrix}\right]$$

The strains are converted to stresses by the following formula:

$$σ = \left[\begin{matrix}{σ}_{x} \\ {σ}_{y} \\ {σ}_{z} \\ {σ}_{x y} \\ {σ}_{y z} \\ {σ}_{z x}\end{matrix}\right] = Σ \times \left[\begin{matrix}{∈}_{x} \\ {∈}_{y} \\ {∈}_{z} \\ {∈}_{x y} \\ {∈}_{y z} \\ {∈}_{z x}\end{matrix}\right]$$

At step 406, the method includes computing a gradient of the single constraint function to determine a direction of force on each of the geometric elements. Further, at step 408, the method includes determining a deformation at the nodes of each of the geometric elements along the determined direction of force. The deformation at a given node of each of the geometric elements may be determined by first defining a first position for a particle, among the plurality of particles, at the given node; then computing a second position after a time step by resolving forces acting on the particle, among the plurality of particles, at the given node; and finally calculating the deformation for the particle, among the plurality of particles, at the given node as the difference between the first position and the second position thereof. Herein, resolving forces acting on the particle, among the plurality of particles, at the given node comprises balancing kinetic energy introduced into a corresponding geometric element against potential energy contained within stresses among the plurality of particles in the geometric element. Collider entities such as spheres, cylinders, and triangles are defined on the points of the mesh. After detecting collisions between such entities, the collision events are converted into constraints to be satisfied by the XPBD solver.

In the most general terms, the deformation and its gradients (rate of change with respect to principal directions) can be conceptually defined for all points of the body/region being simulated, as discussed in the proceeding paragraphs in more detail with reference to some exemplary implementations. Herein, the total energy in the system is computed by integrating the product of strains and stresses over the volume, which is given by:

$$E \left(X\right) = \int {∈}^{T} σ , d v = \int {∈}^{T} Σ ∈ d v$$

### II.C. Linear Tetrahedral Elements

In case of linear tetrahedral elements, as understood, a tetrahedron contains four points at which various values are known. The 3D coordinates of the nodes of a linear tetrahedral element at rest position (i.e. strain is 0) is denoted by P₀,P₁,P₂, and P₃· During a simulation, the current positions of the nodes are denoted by x₀, x₁, x₂, and x₃· The deformations at the nodes are thus given by uᵢ = xᵢ Pᵢ· The deformations are thus known at the nodal positions, but not known at the internal tetrahedral points. Compute the total force and strain energy being experienced by the element due to the deformation includes internal strain energy. This is done using shape functions defined per node, as below:

$${N}_{0} = {ζ}_{0}$$

$${N}_{1} = {ζ}_{1}$$

$${N}_{2} = {ζ}_{2}$$

$${N}_{3} = {ζ}_{3}$$

At step 410, the method includes interpolating the determined deformation at the nodes of each of the geometric elements to the respective entire geometric element. The coordinates

$${ζ}_{1} , \left(i = 0 , 1 , 2 , 3\right)$$

, are referred to material coordinates as they parametrize the tetrahedron with a local coordinate system. These material coordinates always sum to 1 and are each greater than or equal to zero. Such functions help interpolate the positions

$${x}_{i}$$

and deformations over the entire tetrahedral element. The linear tetrahedral element approximates the values discussed in the previous section by means of a tetrahedron. The positions and deformations whose values are maintained at the nodes, are interpolated to the entire tetrahedron via the shape functions.

From the initial positions, the Jacobian that transforms the Cartesian coordinates to the material coordinates is defined as follows,

$$J = \left[\begin{matrix}1 & 1 & 1 & 1 \\ {p}_{{1}_{x}} & {p}_{{2}_{x}} & {p}_{{3}_{x}} & {p}_{{4}_{x}} \\ {p}_{{1}_{y}} & {p}_{{2}_{y}} & {p}_{{3}_{y}} & {p}_{{4}_{y}} \\ {p}_{{1}_{z}} & {p}_{{2}_{z}} & {p}_{{3}_{z}} & {p}_{{4}_{z}}\end{matrix}\right]$$

The matrix P (which represents a matrix of ζᵢ's Cartesian partial derivatives

$$\frac{\partial {ζ}_{\text{i}}}{{\partial }_{x}}$$

may be computed as,

$$P = {J}^{- 1} \times \left[\begin{matrix}0 & 0 & 0 \\ 1 & 0 & 0 \\ 0 & 1 & 0 \\ 0 & 0 & 1\end{matrix}\right]$$

For, the sake of implementation and other formulae, it is convenient to re-declare the elements of P as in terms of variables aₙ, bₙ, cₙ

$$P = \frac{1}{J} \left[\begin{matrix}{a}_{1} & {b}_{1} & {c}_{1} \\ {a}_{2} & {b}_{2} & {c}_{2} \\ {a}_{3} & {b}_{3} & {c}_{3} \\ {a}_{4} & {b}_{4} & {c}_{4}\end{matrix}\right]$$

Here,

$$J$$

is the determinant of the Jacobian.

The matrix B referred to as the strain-displacement matrix, is a 6 × 12 sparse matrix defined based on aₙ, bₙ, cₙ. The entries in B contain only 12 unique values which can be precomputed and stored. Herein B is given by:

$$B = \left[\begin{matrix}{a}_{1} & {a}_{2} & {a}_{3} & {a}_{4} & 0 & 0 & 0 & 0 & 0 & 0 & 0 & 0 \\ 0 & 0 & 0 & 0 & {b}_{1} & {b}_{2} & {b}_{3} & {b}_{4} & 0 & 0 & 0 & 0 \\ 0 & 0 & 0 & 0 & 0 & 0 & 0 & 0 & {c}_{1} & {c}_{2} & {c}_{3} & {c}_{4} \\ {b}_{1} & {b}_{2} & {b}_{3} & {b}_{4} & {a}_{1} & {a}_{2} & {a}_{3} & {a}_{4} & 0 & 0 & 0 & 0 \\ 0 & 0 & 0 & 0 & {c}_{1} & {c}_{2} & {c}_{3} & {c}_{4} & {b}_{1} & {b}_{2} & {b}_{3} & {b}_{4} \\ {c}_{1} & {c}_{2} & {c}_{3} & {c}_{4} & 0 & 0 & 0 & 0 & {a}_{1} & {a}_{2} & {a}_{3} & {a}_{4}\end{matrix}\right]$$

Since B is constant over the linear tetrahedron, the stiffness matrix is also a constant and is given by:

$${K}_{e} = {B}^{T} Σ B$$

Herein, the strains, forces and strain energy over a tetrahedron are constant over the linear tetrahedron. The integral to compute the strain energy is rewritten as follows:

$${E}_{e} \left(U\right) = {U}^{T} {K}_{e} U$$

wherein, U is a column matrix with uᵢ’s stacked. The expression B^{T} ΣE is called the stiffness +matrix and is denoted by K. It is to be noted for further reference that to compute the energy, the required parameters are the deformations U (12 values), the strain-deformation matrix B (12 values), the constitutive matrix ∑ (2 values).

In case of non-linear elements, the above described implementation of the constraint functions is easily extendible. The accuracy of any stable simulation scales with the number of nodes or elements that are used to represent the body to be simulated. As the number of particles or nodes increase, the accuracy of the simulation converges to the exact solution. When using a finite element method, the increase in points correspond to an increase in the number of elements that represent the material modelled. Arbitrarily increasing the number of elements to extract a more accurate solution is often infeasible owing to the limited computing resources available and is especially so in real-time haptics simulations. A way to circumvent this difficulty in the case of a requirement of extremely accurate solutions (for example in the case of large deformations) while retaining the real-time speed of the simulation, is to use non-linear elements to describe the material. Non-linear elements can capture a larger range of solutions with fewer elements. Using non-linear elements in conventional simulation techniques requires considerable effort in implementation and is not be directly possible without major adjustments to the formulation itself. In the definition of the constraint given above, the implementation is relatively easy, requiring only changes to the quantities that define the element itself and some minor modifications to the constraint function to accommodate the new element. This expands the scope of efficient, accurate, real-time simulations to those with larger deformations as well while retaining the ease of implementation.

### II.D. Quadratic Tetrahedral Element

Further, representing complex material geometries using linear elements requires many points and this in turn increases the computational load in simulations. With a view to improving the surface representation with fewer elements, nonlinear elements are used. The isoparametric quadratic tetrahedron is one such nonlinear element wherein apart from just the corner nodes, nodes for sides or faces are also used to describe an element. This allows accurate representation of geometries that have smooth and continuous curvature. For instance, a standard 10 node element is considered. In such case, the corner nodes, representing the edges of the tetrahedron are numbered locally from 1 through 4. The side nodes located at the mid points of the sides 12, 23, 31, 14, 24 and 34 are numbered from 5 through 10. The natural coordinates of the tetrahedron are given by ζᵢ, i = 1,2,3,4. Given the positions and displacements at nodes, one obtains the positions and displacements at all points within the element by interpolation as follows,

$$\left[\begin{matrix}1 \\ x \\ y \\ z \\ {u}_{x} \\ {u}_{y} \\ {u}_{z}\end{matrix}\right] = \left[\begin{matrix}1 & 1 & 1 & … & 1 \\ {x}_{1} & {x}_{2} & {x}_{3} & … & {x}_{10} \\ {y}_{1} & {y}_{2} & {y}_{3} & … & {y}_{10} \\ {z}_{1} & {z}_{2} & {z}_{3} & … & {z}_{10} \\ {u}_{x 1} & {u}_{x 2} & {u}_{x 3} & … & {u}_{x 10} \\ {u}_{y 1} & {u}_{y 2} & {u}_{y 3} & … & {u}_{y 10} \\ {u}_{z 1} & {u}_{z 2} & {u}_{z 3} & … & {u}_{z 10}\end{matrix}\right] \left[\begin{matrix}{N}_{1}^{e} \\ {N}_{2}^{e} \\ {N}_{3}^{e} \\ {N}_{4}^{e} \\ {N}_{5}^{e} \\ … \\ {N}_{10}^{e}\end{matrix}\right]$$

Further, the shape functions

$${N}_{1}^{e} ,$$

$${N}_{2}^{e} …$$

are expressed in terms of natural tetrahedral coordinates as follows:

$${N}_{1}^{e} = {ζ}_{1} \left(2 {ζ}_{1} - 1\right) , {N}_{2}^{e} = {ζ}_{2} \left(2 {ζ}_{2} - 1\right) , {N}_{3}^{e} = {ζ}_{3} \left(2 {ζ}_{3} - 1\right) , {N}_{4}^{e} = {ζ}_{4} \left(2 {ζ}_{4} - 1\right) ,$$

$$\begin{matrix}{N}_{5}^{6} = 4 {ζ}_{1} {ζ}_{2} , {N}_{5}^{3} = 4 {ζ}_{2} {ζ}_{3} , {N}_{7}^{6} = 4 {ζ}_{1} {ζ}_{3} , {N}_{8}^{6} = 4 {ζ}_{1} {ζ}_{4} , {N}_{9}^{5} = \\ 4 {ζ}_{2} {ζ}_{4} , {N}_{10}^{6} = 4 {ζ}_{3} {ζ}_{4} .\end{matrix}$$

The partial derivatives of these shape functions,

$$' \frac{\partial {N}_{k}}{\partial {ζ}_{1}}$$

with respect to the Cartesian coordinate system can be computed by chain rule. Here, ^{i = 1, ... 4} iterates over the material coordinate

$${ζ}_{6 ,}$$

and ^{k}⁼¹^{...,10} iterates over the node functions Nₖ.

The superscript ^{ε} on the node functions (and other places) are dropped where the context is clear that it pertains to the element being considered.

For clarity, the partial derivative will usually be evaluated at an interior point ^{q} with material coordinates ζᵢ^{(q)}(i= 1...4).

The Jacobian that arises during the coordinate transformation of the material frame to the Cartesian frame is given by:

$$I = \left[\begin{matrix}1 & 1 & 1 & 1 \\ {\sum }_{k} {x}_{k} \frac{\partial {N}_{k}}{\partial {ζ}_{1}} & {\sum }_{k} {x}_{k} \frac{\partial {N}_{k}}{\partial {ζ}_{2}} & {\sum }_{k} {x}_{k} \frac{\partial {N}_{k}}{\partial {ζ}_{3}} & {\sum }_{k} {x}_{k} \frac{\partial {N}_{k}}{\partial {ζ}_{4}} \\ {\sum }_{k} {y}_{k} \frac{\partial {N}_{k}}{\partial {ζ}_{1}} & {\sum }_{k} {y}_{k} \frac{\partial {N}_{k}}{\partial {ζ}_{2}} & {\sum }_{k} {y}_{k} \frac{\partial {N}_{k}}{\partial {ζ}_{3}} & {\sum }_{k} {y}_{k} \frac{\partial {N}_{k}}{\partial {ζ}_{4}} \\ {\sum }_{k} {z}_{k} \frac{\partial {N}_{k}}{\partial {ζ}_{1}} & {\sum }_{k} {z}_{k} \frac{\partial {N}_{k}}{\partial {ζ}_{2}} & {\sum }_{k} {z}_{k} \frac{\partial {N}_{k}}{\partial {ζ}_{3}} & {\sum }_{k} {z}_{k} \frac{\partial {N}_{k}}{\partial {ζ}_{4}}\end{matrix}\right]$$

Here, xₖ, yₖ, zₖ,(k= 1.0.10) are the Cartesian coordinates of the k^{th} node. To compute the Jacobian

$$J$$

, the Cartesian coordinates of the nodes xₖ, yₖ, zₖ,(k = 1.0.10) and some interior point q with material coordinates ζᵢ^{(q)}(i= 1.0.4) are required as input.

A matrix P may also be pre-computed (which represents a matrix of Cartesian partial derivatives

$$\frac{\partial {ζ}_{i}}{\partial x}$$

etc. that,

$$P = {J}^{- 1} \times \left[\begin{matrix}0 & 0 & 0 \\ 1 & 0 & 0 \\ 0 & 1 & 0 \\ 0 & 0 & 1\end{matrix}\right]$$

For, the sake of implementation and other formulae, it is convenient to re-declare the elements of P as in terms of the variables aₙ, bₙ, cₙ

$$P = \frac{1}{J} \left[\begin{matrix}{a}_{1} & {b}_{1} & {c}_{1} \\ {a}_{2} & {b}_{2} & {c}_{2} \\ {a}_{3} & {b}_{3} & {c}_{3} \\ {a}_{4} & {b}_{4} & {c}_{4}\end{matrix}\right]$$

Here,

$$J$$

is the determinant of the Jacobian. The shape function Cartesian derivatives are given by,

$$\begin{matrix}\frac{\partial {N}_{n}}{\partial x} = \left(4 {\text{ζ}}_{n} - 1\right) \frac{{a}_{n}}{J} , \frac{\partial {N}_{n}}{\partial y} = \left(4 {\text{ζ}}_{n} - 1\right) \frac{{b}_{n}}{J} , \\ \frac{\partial {N}_{n}}{\partial z} = \left(4 {\text{ζ}}_{n} - 1\right) \frac{{c}_{n}}{J} , \left(n = 1..4\right)\end{matrix}$$

$$\begin{matrix}\frac{\partial {N}_{m}}{\partial x} = 4 \frac{{a}_{i} {\text{ζ}}_{j} - {a}_{j} {\text{ζ}}_{i}}{J} , \frac{\partial {N}_{m}}{\partial y} = 4 \frac{{b}_{i} {\text{ζ}}_{j} - {b}_{j} {\text{ζ}}_{i}}{J} , \\ \frac{\partial {N}_{m}}{\partial z} = 4 \frac{{c}_{i} {\text{ζ}}_{j} - {c}_{j} {\text{ζ}}_{i}}{J} , \begin{matrix}\left(m = 5 , 6 , 7 , 8 , 9 , 10\right) \\ \left(i = 1 , 2 , 3 , 1 , 2 , 3\right) \\ \left(j = 2 , 3 , 1 , 4 , 4 , 4\right)\end{matrix}\end{matrix}$$

The strain displacement matrix is defined as

$$B = \frac{1}{I} \left[\begin{matrix}\frac{\partial {N}_{1}}{\partial x} & 0 & 0 & \frac{\partial {N}_{2}}{\partial x} & 0 & 0 & … & \frac{\partial {N}_{10}}{\partial x} & 0 & 0 \\ 0 & \frac{\partial {N}_{1}}{\partial y} & 0 & 0 & \frac{\partial {N}_{2}}{\partial y} & 0 & … & 0 & \frac{\partial {N}_{10}}{\partial y} & 0 \\ 0 & 0 & \frac{\partial {N}_{1}}{\partial z} & 0 & 0 & \frac{\partial {N}_{2}}{\partial z} & … & 0 & 0 & \frac{\partial {N}_{10}}{\partial z} \\ \frac{\partial {N}_{1}}{\partial y} & \frac{\partial {N}_{1}}{\partial x} & 0 & \frac{\partial {N}_{2}}{\partial y} & \frac{\partial N 2}{\partial x} & 0 & … & \frac{\partial {N}_{10}}{\partial y} & \frac{\partial {N}_{10}}{\partial x} & 0 \\ o & \frac{\partial {N}_{1}}{\partial z} & \frac{\partial {N}_{1}}{\partial y} & 0 & \frac{\partial {N}_{2}}{\partial z} & \frac{\partial {N}_{2}}{\partial y} & … & 0 & \frac{\partial {N}_{10}}{\partial z} & \frac{\partial {N}_{10}}{\partial y} \\ \frac{\partial {N}_{1}}{\partial x} & 0 & \frac{\partial {N}_{1}}{\partial z} & \frac{\partial {N}_{2}}{\partial z} & 0 & \frac{\partial {N}_{2}}{\partial x} & … & \frac{\partial {N}_{10}}{\partial x} & 0 & \frac{\partial {N}_{10}}{\partial z}\end{matrix}\right]$$

Here,

$$J$$

is the determinant of the Jacobian that arises during the coordinate transformation of the material frame to the tetrahedron’s natural coordinate frame. B and

$$J$$

are non-constant over the quadratic tetrahedral element. To compute the Jacobian determinant

$$J$$

and the strain-displacement matrix, the Cartesian coordinates of the nodes xₖ, yₖ, Zₖ,(k = 1.0.10) and some interior point q with material coordinates ζᵢ^{(q)}(i = 1..0.4) are required as input. Thus, the strain displacement matrix at an interior point q is a matrix function

$${B}^{( q )} ( {ζ}_{i}^{( q )} , {x}_{k} , {y}_{k} , {z}_{k} )$$

The element stiffness matrix is defined as

$$K = \int {B}^{T} Σ B d v$$

A standard numerical integration technique, such as 4-point Gaussian quadrature or another numerical integration technique may be used to evaluate the above integral. In this technique, four sets of constant material coordinate values ζᵢ^{(q)}(i = 1.0.4), (q = 1.0.4) and 4 weights w^{(q)} may be used to numerically evaluate the stiffness matrix as

$$K = {\sum }_{q = 1.4} {w}^{\left(q\right)} {B}^{{\left(q\right)}^{τ}} Σ {B}^{\left(q\right)}$$

In some cases, a quadratic tetrahedral element may be implemented which is an extension of the previous element with extra points on the edges of the linear tetrahedron. The number of nodes in case of quadratic tetrahedral element are ten, for the four vertices and six edges. This may permit use of closed form analytic expressions with co-linear nodes on midpoint of edges. This will allow to compute non-linear geometric representations. Another advantage will be that the strain can be linear in an element (as opposed to constant in the case of linear tetrahedron). In other cases, the elements may be cubic, prismatic, or other solids. In general, a solid element will be represented as a number of particles that is the sum of the number of vertices and the number of edges.

In the present implementations, the representation of a material surface in the simulation, consists of modelling the surface as a set of points connected by, for example, triangles. To form a surface with thickness, the points are extruded along the normal direction of the surface they represent. Intuitively, one may visualize each triangle being extruded into a prism like object. Each prism like object can be broken into 3 tetrahedral elements. These make up the FEM tetrahedral elements. These tetrahedral elements are structures that hold the stiffness parameters relevant to the material, such as Young’s modulus and Poisson ratio, thus resembling a surface with a finite thickness and adjustable stiffness. A model thus generated accurately simulates tissue behaviour, which finds applications in medical simulations. These tetrahedral elements can be extended to any number of layers depending on the nature of the material simulated.

### III. FEM-XPBD Computation

FEM (Finite Element Model) based constraint functions may be combined for use in the XPBD simulation framework. Given a finite element e and the deformation U at the nodes of the element, the FEM-XPBD constraint Cₑ is defined. This constraint leads to reconcile the FE strain energy term Eₑ with the XPBD energy term. Furthermore, a standard FE expressions to compute the forces Fₑ experienced at the nodes of the tetrahedron e is used. Finally, the expression for the gradient of the FEM-XPBD constraint (denoted by ∇Cₑ) is derived, which is needed in the XPBD simulation framework. That is, first the FEM-XPBD constraint over a FE element e is defined as:

$${C}_{e} \left(U\right) = \sqrt{{U}^{T} {K}_{e} U}$$

where, Kₑ = ∫ B^{T}∑B dv is the stiffness matrix computed over the element e. Then, the element energy analogous to XPBD’s constraint energy definition is defined as:

$${E}_{e} \left(U\right) = \frac{1}{2} \times {C}_{e} \left(U\right) \times α \times {C}_{e} \left(U\right)$$

where, α is XPBD’s compliance parameter. Plugging in the equation from the previous step,

$${E}_{e} \left(U\right) = \frac{1}{2} α {U}^{T} {K}_{e} U$$

which is the same as the FEM element energy scaled by the compliance parameter α. The force being experienced on the nodes of an element is given by the gradient of energy as:

$${F}_{e} \left(U\right) = ∇ {E}_{e} \left(U\right) = α \times {C}_{ε} \left(U\right) \times ∇ {C}_{ε} \left(U\right)$$

The above equation may be simplified as:

$$∇ {E}_{e} \left(U\right) = α {U}^{T} {K}_{∈}$$

Further, the expression for the gradient of FEM constraint from the above two equations is derived as:

$$∇ {C}_{e} \left(U\right) = \frac{{U}^{T} {K}_{e}}{{C}_{e} \left(U\right)}$$

The above definitions and derivations are valid for all FE based methods, and the mathematical expressions to compute K_{ε} for generic finite elements flow from standard FE algorithms.

An example of a spring constraint between two particles is cⱼ([x₁,x₂])= ||x₁ – x₂ | – L|. This simply states that the Euclidean distance between two points should be L. XPBD will try to ensure that the constraint achieves a value of ‘0’. The value of the constraint (Cᵢ) will be the deformation of the spring. Thus, the energy will take the familiar form for the energy of a spring, i.e.

$$K \frac{{u}^{2}}{2}$$

.

Generally, the constitutive matrix (∑) for each of the geometric elements is given by:

$$Σ = \text{Y} \text{.} {Σ}_{v} ,$$

wherein ‘Y’ is the Young’s modulus and is a constant that relates stresses and strains on a given geometric element so long as the stress and the strain are linearly related, and ‘∑ᵥ’ is the constitutive matrix with only Poisson ratio (v) terms.

The present implementations establish a connection with FEM based formulation of energy as well as the constraint definition required by XPBD. Herein, first, the FEM constitutive matrix ∑ is rewritten as Y ∑ᵥ, where Y is the Young’s modulus, ∑ᵥ is the constitutive matrix with only the Poisson ratio terms. Herein, the tetrahedral FEM constraint is defined as below:

$${C}_{1} \left(U\right) = \sqrt{{U}^{T} K U}$$

wherein, K =

$$K = \sqrt{\int {B}^{T} Σ B d v}$$

is the stiffness matrix computed over the entire element or the domain. This constraint is a description of the strain energy of the FEM element under consideration and its gradient provides the direction of the net force along which the positions should be updated. The strain energy describes the energy that gets accumulated on account of the deformations that the element undergoes.

The nodal deformation U is simply X - X₀, where X₀ is the position of the particles at the starting of the simulation. B is the matrix that relates the elemental strains to the nodal displacements. In the context of the finite element method, this matrix contains different constants that arise as a constructing the tetrahedral element using the shape functions or also known as the tetrahedral coordinates and is of the form,

$$B = \left[\begin{matrix}{a}_{1} & {a}_{2} & {a}_{3} & {a}_{4} & 0 & 0 & 0 & 0 & 0 & 0 & 0 & 0 \\ 0 & 0 & 0 & 0 & {b}_{1} & {b}_{2} & {b}_{3} & {b}_{4} & 0 & 0 & 0 & 0 \\ 0 & 0 & 0 & 0 & 0 & 0 & 0 & 0 & {c}_{1} & {c}_{2} & {c}_{3} & {c}_{4} \\ {b}_{1} & {b}_{2} & {b}_{3} & {b}_{4} & {a}_{1} & {a}_{2} & {a}_{3} & {a}_{4} & 0 & 0 & 0 & 0 \\ 0 & 0 & 0 & 0 & {c}_{1} & {c}_{2} & {c}_{3} & {c}_{4} & {b}_{1} & {b}_{2} & {b}_{3} & {b}_{4} \\ {c}_{1} & {c}_{2} & {c}_{3} & {c}_{4} & 0 & 0 & 0 & 0 & {a}_{1} & {a}_{2} & {a}_{3} & {a}_{4}\end{matrix}\right]$$

wherein, the aᵢ,bᵢ,cᵢ,are constants that arise from the initial configuration X₀. Further, the material property matrix is given by,

$$E = \frac{Y}{\left(1 + v\right) \left(1 - 2 v\right)} \left[\begin{matrix}1 - v & v & v & 0 & 0 & 0 \\ v & 1 - v & v & 0 & 0 & 0 \\ v & v & 1 - v & 0 & 0 & 0 \\ 0 & 0 & 0 & \frac{1}{2} - v & v & 0 \\ 0 & 0 & 0 & 0 & \frac{1}{2} - v & 0 \\ 0 & 0 & 0 & 0 & 0 & \frac{1}{2} - v\end{matrix}\right]$$

wherein, Y is the Young’s modulus and v is the Poisson’s ratio, which represents lateral strain. This is the matrix that relates the stress and the strain under the assumption of linear elasticity, through the equation, σ = Ee; wherein, e is the strain vector. This is also called the constitutive equation.

Conservation of energy ensures realistic deformations that preserve the shape of the tissue. Each element in part is a representation of the surface of a tissue. The elements contain within it: values for stiffness, Young’s Modulus and Poisson’s ratio. In most material behaviour, the Young’s modulus is a constant that relates the stresses and strains so long as the stress and the strain are linearly related. An advantage in using the given formulation for the constraint is the ease with which Y can be tuned to accommodate accurate tissue behaviour.

For the use of the given constraint in XPBD framework, the gradient of the constraint may be computed as follows.

$${F}_{e} \left(U\right) = ∇ {E}_{e} \left(U\right) = a \times {C}_{e} \left(U\right) \times ∇ {C}_{e} \left(U\right)$$

Wherein, E is the strain energy as defined earlier, namely

$${E}_{e} \left(U\right) = \frac{1}{2} {C}_{j} {α}^{- 1} {C}_{j}$$

and α is the compliance parameter.

The above equation may be simplified as

$$∇ {E}_{e} \left(U\right) = a {U}^{T} {K}_{e}$$

The gradient of energy is the force (ref) which is given as,

$${F}_{e} = {U}^{T} {K}_{e}$$

Therefore, the gradient of the constraint function now becomes,

$$∇ {C}_{j} \left(U\right) = \frac{{U}^{T} {K}_{e}}{{C}_{j}}$$

The gradient of the constraint function is the direction along which the positions are updated in this direction. The stiffness matrix K_{ε} is an integral that is computed over the volume of the entire element. For linear tetrahedron a closed form solution exists and this can be used directly to compute K_{ε}. In the case of quadratic tetrahedrons, a closed form solution exists only if the initial mid side nodes are collocated at the mid points between adjacent corners (ref). For the general case defining the initial mid-side points, a Gaussian quadrature method of numerical integration can be used. The method described herein is equally applicable to the global method or the elemental stiffness method.

In case of global stiffness method, the entire mesh is considered all at once, consisting of all the elements that make up the body being simulated. A global stiffness matrix is then constructed, and the strain energy and the constraints are computed in the ways described above. In such case, the stiffness matrix would consist of 465 elements from the matrix of shape functions B, 30 initial elemental nodal positions, the material constants including Y (Young’s modulus) and v (Poisson’s ratio), totalling 497 floating point values. This would generally correspond to approximately 100 arithmetic operations and 500 data fetches. This method would thus have fewer compute operations. In case of local/elemental stiffness method, the strain energy and the constraints are computed on each individual element and position updates are applied locally to these elemental nodes. This consists of assembling the stiffness matrix K with 90 elements from shape functions B, 30 initial elemental node positions, the material constants including Y (Young’s modulus) and v (Poisson’s ratio), totaling 122 floating point values. This method would have the required memory usage going down dramatically.

In an example, the precomputation steps for each linear tetrahedron is as follows: (i) considering that the element strain-displacement matrix B is a constant for linear tetrahedra, 12 floating point values are precomputed and stored to reassemble B; (ii0 then, the initial positions of the particles X₀ are stored using 12 floating point values; and (iii) subsequently a set of 1-5 coefficients are stored per tetrahedron to reconstruct the stress strain relationship curve. Herein, the GPU solves the FEM-XPBD constraint using one thread for each linear tetrahedron in the following steps: (i) the current positions of the tetrahedrons points are read from the global buffer of all particles as X; (ii) the element strain vector _{E} is computed as B × (X - X₀) resulting in the 6 strain components, (iii) the constitutive matrix ∑ is computed using ε and the stress strain relationship curve; (iv) the element stiffness matrix K_{ε} is computed as B^{T}∑B; and (v) the expressions for C_{ε} and ∇C_{ε} are computed as per the formulas in the preceding paragraphs to be further used by XPBD’s framework.

### III.A. Quadratic Tetrahedrons

The simplest non-linear element is a quadratic tetrahedron. For this case, the full computation follows. First, a few matrices are precomputed per element, that may remain constant during the simulation:
1. The material space coordinates and weight of 4 quadrature points
$${ζ}_{i} {}^{\left(q\right)}$$
and w^{(q)} are stored as constant values based on quadrature rules [3]. q = 1, ..., 4 refers to the index of the quadrature point, i = 1, ... ,4 refers to the index of the material space coordinate
$${ζ}_{i}^{( q )}$$
is the i^{th} material coordinate for the q^{th} quadrature point. w^{(q)} is the weight for the q^{th} quadrature point.
2. The initial positions tetrahedron nodal positions are read from the global buffer of all particles' initial positions X⁰ as xₖ ,yₖ, zₖ(k = 1.0.10).
3. For each quadrature point q.
i. Compute J^{(q)} using
$${x}_{k} , {y}_{k} , {z}_{k} , {ζ}_{i}^{\left(q\right)}$$
(see eq 4.1)
ii. Compute P^{(q)} using J^{(q)}(see eq 4.2)
iii. Compute
$$\frac{\partial {N}_{k}}{\partial x} , \frac{\partial {N}_{k}}{\partial y} , \frac{\partial {N}_{k}}{\partial z}$$
using elements from P^{(q)} and
$${ζ}_{i}^{( q )}$$
(see eq 4.4a, 4.4b)
iv. Compute B^{(q)}using the previous step (see eq 4.5)
4. The young’s modulus and (Y) and Poisson (v) ratio are read and assembled into the element’s constitutive matrix ∑ is assembled using Y and v (see eq 2.1)
5. The element stiffness matrix K^{e} is computed using the B^{(q)}(q = 1.0.4) and Σ (see eq 4.8)

A parallel processor solves each FEM-XPBD constraint at every inner step of the XPBD solver using one thread for each quadratic tetrahedron in the following steps
1. The predicted positions of the element’s nodal positions
$${x}_{k}^{p} , {y}_{k}^{p} , {z}_{k}^{p} \left(k = 1..1.0\right)$$
are read from the particles' predicted position X^{P}.
2. The initial positions element’s nodal positions are read from the particles' initial positions X⁰ as xₖ,y_{k,}zₖ(k = 1.0.10)
3. Compute the deformations
$${u}_{{x}_{k}} = {x}_{k}^{p} - {x}_{k} , {u}_{{y}_{k}} = .. , {u}_{{z}_{k}} = .. \left(k = 1..10\right)$$
4. Assemble the element displacement vector
$$U = \left[{u}_{{x}_{k}} , {u}_{{y}_{k}} , {u}_{{z}_{k}} , …\right] \left(k = 1..10\right)$$
5. The values for Cₑ and ∇Cₑ are computed as per the formulas in the invention using the Kₑ and U as inputs (See eq 1.1 and 1.3)
6. Cₑ and ∇Cₑ are further used by XPBDs framework.

This technique may permit modeling of non-linear element in real-time computation.

Another variation permits the modeling of a non-linear elastic model, where the constitutive matrix ∑ is defined based on the strain ∈⁽^{q)} at an interior point of the element.Non-linear elastic models may be useful when materials are anisotropic. The material properties may also be varied based on the internal material coordinates

$${\text{ζ}}_{i}^{\left(q\right)}$$

or even the previous strain values ∈⁽^{q)}. In that case, steps 4 and 5 are omitted in the precomputation step. Instead, in the solving of the FEM-XPBD constraint, after step 4, the following steps are inserted.
1. For each quadrature point q
   i. Compute the strain as ∈^{(q)} =B^{(q)}U.
   ii. Obtain the constitutive matrix ∑^{(q)} using ∈^{(q)} and/or the ζᵢ^{(q)} and or the previous ∈^{(q)}
2. Compute the elements stiffness matrix Kₑ (using a modified form of eq 4.8 with ∑^{(q)} instead of ∑ )
The remaining steps proceed as before with this stiffness matrix Kₑ

In another example, the precomputation steps for each linear tetrahedron is as follows:
1. The initial positions tetrahedron nodal positions are read from the global buffer of all particles' initial positions X⁰ as xₖ, yₖ, zₖ (k = 1.4)
2. The strain displacement matrix B for the linear tetrahedron is computed (see eq 3.4).
3. The element stiffness matrix K^{ε} is computed using the B(q = 1.0.4) and ∑ (see eq 3.6)

The parallel processor may compute the FEM-XPBD constraint using one thread for each linear tetrahedron in the following steps:
1. The predicted positions of the element’s nodal positions
$${x}_{k}^{p} , {y}_{k}^{p} , {z}_{k}^{p} \left(k = 1..4\right)$$
are read from the particles' predicted position X^{p};
2. The initial positions element’s nodal positions are read from the particles' initial positions+ X⁰ as xₖ, yₖ, zₖ (k = 1.0.4)
3. Compute the deformations
$${u}_{x k} = {x}_{k}^{p} - {x}_{k} , {u}_{y k} = . , {H}_{E k} = , . \left(k = 1..4\right)$$
4. Assemble the element displacement vector
$$U = \left[{u}_{x k} , {u}_{y k} , {u}_{z k} , ...\right] \left(k = 1.4\right)$$
5. The values for Cₑ and ∇Cₑ are computed as per the formulas in the invention using the Kₑ,and U as inputs (see eq 1.1 and 1.3)
6. Cₑ and ∇Cₑ, are further used by XPBDs framework

Because non-linear functions for individual elements allow more-complete capture of the behaviour of individual elements, the subdivision/mesh of the physical body may be coarser, that is, using fewer elements. Because the computational complexity of finite element modelling or position-based modelling grows with n² in the number of geometric elements, where the complexity of the non-linear terms generally grows linearly with the growth of the order of the functions, overall computational complexity may be reduced. This may permit real-time modelling of phenomena.

The above algorithms may be implemented in a CPU like parallel processor where each thread works independently on each constraint, or a GPU like parallel processor, where more than one thread is allocated to process a constraint. This may be necessary when the memory latency is large when compared to the computational cost. In some cases, it may be more efficient to store the initial data and recompute the intermediate matrix products when the runtime deformations are available. For example, precomputing the stiffness matrix K_{ε} would have 900 numbers for a quadratic tetrahedron. Thus, each thread would have to load 900 values, perform a multiplication of this matrix with the 30-element displacement vector. This would result in 27000 floating point operations (flops). In contrast, it may be more efficient to store, per element, the starting positions of the element xₖ, yₖ, zₖ (k = 1.0.10), the quadrature points' data

$${w}^{\left(a\right)} , {ς}_{∈}^{\left(a\right)} , {J}^{\left(a\right)} , {a}_{i}^{\left(a\right)} , {b}_{i}^{\left(a\right)} , {c}_{i}^{\left(a\right)} \left(q = 1..4 , i = 1..4\right) .$$

In total, it would require only ~100 floating point numbers to be loaded. 4 threads may work on a constraint, wherein each thread loads in ¼^{th} the data into a data buffer shared by all 4 threads. Then, the 4 threads may compute B^{(q)}U (180 flops), and ∑B^{(q)} (270 flops) with each thread handling one = 1.0.4 . The total computation could be reduced to under 2500 flops to compute Cₑ and ∇Cₑ. In many cases, ∑ is generated from 2 values and B^{(q)} is generated from 30 values. Using a symbolic processor, the computation of ∑B^{(q)}(270 flops) could be further reduced. Other threading schemes and generative vs precomputation schemes on similar lines could be employed to obtain computational efficiencies, while minimizing memory latencies.

When higher accuracies are desired, other numerical integration techniques schemes may be employed such as the 10 point Gaussian quadrature rules. This would have implications on the precomputation vs on the fly computation schemes from an efficiency stand point. As the numerical integration complexity increases, it may be more efficient to precompute and store Kₑ. In such cases, it would be prudent to leverage the moderate sparseness and symmetricity of the matrix Kₑ. A symbolic processor, and/or sparse matrix techniques, may also be used to generate efficient code for the same.

In one example, the proposed framework can be implemented by computing the Lagrange Multiplier change Δλ and computing the position change Δx (based on the Lagrange Multiplier change Δλ). These are computed based on the constraint formulation which is discussed in the preceding paragraphs. This constraint unifies FEM into a real-time simulation framework. Further the present implementation involves updating the Lagrange Multiplier λᵢ₊₁ and updating the position xᵢ₊₁ accordingly. In another example, the proposed framework can be implemented by predicting position x̂, then initializing position x₀, then initializing Lagrange Multiplier λ₀, updating Lagrange Multiplier λᵢ₊₁ using Δλ, and subsequently updating position xᵢ₊₁ using Δx. These updates are computed based on novel definitions of constrains as provided by the proposed framework. Finally, the positions xⁿ⁺¹ and velocities vⁿ⁺¹ are updated.

### III.B. Time Stepping

The equations of motion are a time evolution dynamic system, where the points that represent the body are projected forward in time. The projection of these points in the constrained direction involves solving a non-linear system of equations that contain the constraint and the compliance matrix parameters. In time evolution equations, such as the one being solved here, regardless of the method of integration, the choice of the time step is important in generating stable numerical solutions. Too large a time-step results in unstable solutions and too small a time step, results in extremely slow convergence rates. In general, choosing a fixed time step leads to difficulties with the conflict between slow convergence and generating stable solutions. Here a time step choice is made that enables fast convergence while retaining the stability of the methods used.

The present disclosure further provides a computer program product comprising at least one non-transitory computer-readable storage medium having computer-executable program code instructions stored therein, the computer-executable program code instructions comprising program code instructions to perform the steps of method as described above.

In some implementations, the system of the present disclosure further implements an artificial neural network (ANN, not shown) for enhancing real-time simulation of the elastic body. The memory of the present system is configured to store data generated for simulation of the elastic body to be used as one or more of training a neural network and to be utilized by a neural network. The system implements a neural network utilizing the stored data for enhancing real-time simulation of other elastic bodies. The ANN is trained on data from the current disclosure or other sources, where the outcome of the simulation from present disclosure is enhanced by the ANN. Also, such or any other ANNs may be trained by the outputs of the present disclosure. In one implementation, a depth map constructing neural network may be trained using the simulation data generated by the system of the present disclosure. For example, a neural network model, such as CNN or RNN using frameworks such as TensorFlow, Dark Net, Keras, may be trained with the data generated by the systems and methods of the present disclosure and/or used as a layer atop the systems and methods of the present disclosure. The neural network may utilize past simulation data for similar objects (elastic bodies) for interpolating the determined deformation at the nodes of each of the geometric elements to the respective entire geometric element, to achieve better and faster simulation outcomes. Herein, the data being generated using the method described above is used for training the neural network. In one implementation, a depth map constructing neural network may be trained using the simulation data generated by the system of the present disclosure.

The simulation framework proposed in the present disclosure, involving novel definitions of FEM (Finite Element Model) based constraint functions to be used in the XPBD simulation framework, solves elastic problem in efficient and more accurate manner in real-time. The present framework is suitable for virtual Interactions, such as in Virtual Reality (VR) and Mixed Reality (MR) interactions. The simulation framework may be used in medical simulations. With the ever-increasing computing power, medical simulation-based devices are gaining popularity, and realistic real-time simulations of tool tissue interactions are now becoming realizable on existing hardware. The present framework proposes techniques to simulate tissue behavior in real-time without compromising on accuracy, which is an outstanding challenge.

### IV. Uses in Simulation, Modelling, Numerical Control

The systems and methods as disclosed herein can be implemented in haptic devices (in one example) which work on the principle of dynamically adjusting forces at an end effector based on the user’s interactions with a virtual environment while holding the haptic device. In an interacting tool/haptic device, an element that undergoes stretching as a result of the force applied by the interacting tool/haptic device, exerts an equal and opposite force on the interacting tool/haptic device. When the user pushes the interacting tool/haptic device against the modelled tissue, the user experiences a force that is computed by this gradient function. The gradient of the energy computed from the above constraint is the force acting on the tissue which is sent back to the user as a reaction force. The gradient of the energy thus computed represents the force that is contained in the tissue as a result of its stretching and this stretched tissue exerts an equal and opposite force on the tool/device.

A use case of haptic interaction is in medical device simulations such as cannulation of a needle through different layers of tissue in the skin. Cannulation is the process of injecting a needle to the patient. The needle penetrates the vein by going through multiple layers of tissue with varying stiffness. The haptic device is a representation of the needle used by the doctor. A virtual reality environment using standard VR headsets provide the visual effects for the user operating on a patient. The device’s movements are mapped to the VR simulated environment. The present disclosure with the FEM based XPBD based framework provides an advantage as in the ability to simulate such behaviour in real time. In the XPBD-FEM based simulation, the FEM elements respond to dynamic loads applied in real time and the compression or extension of the elements is used to compute a force that is fed back to the haptic device. The force computed being based on FEM elements, whose parameters can be tuned to mimic material behaviour, enable accurate and fully immersive simulations of real time physics. In the present implementations, the point for injecting on the patient’s arm is modelled as an extruded mesh with three different layers, each with different stiffness parameters. As the device is moved by the user towards the tissue, it applies an external force, that causes the tissue to deform. The tissue dynamics being simulated by the XPBD-FEM model, deforms appropriately. It offers a force feedback fed to the haptic device that offers resistance to the user’s motion. On further application of load by the user, the tissue layer breaks, that is, the tetrahedral elements are broken at the point of contact and the user feels a relief in resistance till they reach the next layer.

Consider an example of a user holding a physical needle like object and virtual reality scene (rendered with a headset) with tissue and a virtual representation of the needle. Pushing the needle against a rigid wall would feel different from a tool tissue interaction. Psychomotor experiments have indicated that for the human sense of touch, the interactions have to be updated at 1000 Hz i.e. every millisecond. In other words, for the sense of immersion to be maintained in a virtual environment coupled with haptic devices, the computations need to perform at 1 KHz. The present framework support haptics interaction (haptic rendering) that requires higher computation rates of ~1 kHz.

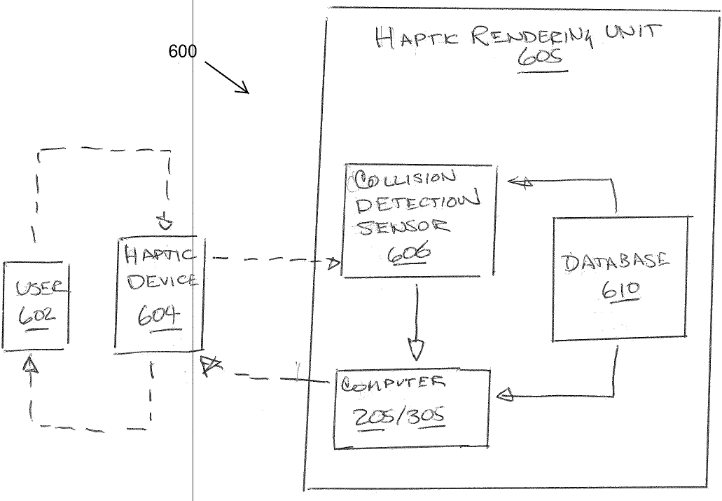

FIG. 6 provides an exemplary schematic depicting implementation of a haptic system 600. Herein, a user 602 provides process and orientation as input to a haptic device 604. The haptic device 604 with its sensor measuring process and orientation input provides sensor readings as input to a haptic rendering unit 605. In particular, the sensor readings are inputted to a sensor 606, in the form of collision detection unit 606, which in turn provides collision test result. For this purpose, the collision detection unit 606 may receive object geometry data from a database 610, in the form of an object database 610. The collision test result from the collision detection unit 606, along with object geometry data as well object physical properties data from the object database 610, are inputted to the proposed system 205 (such as the system 100) implementing FEM based XPBD framework as disclosed in the present disclosure. Herein, the processing unit (such as, the CPU 205 and/or 305 of the system 100) is configured to define the single constraint function for each of the geometric elements of the elastic body based on the information about geometry of the elastic body and the said measured force. The system 205 performs the necessary calculations (as discussed above) to provide actuator readings to the haptic device 604. The haptic device 604 in turn processes the actuator readings to determine force and torque to be fed to the user 602.

The tissue and the tool are discretized using tetrahedral elements. The force being experienced by the elements of the tool are read and used for haptic feedback using a robotic system. This is a resultant of the tool interacting with the tissue. For example, while piercing a needle into a tissue, modelled with multiple layers of stiffness, the different elastic forces Fₑ through those layers is experienced by the user through the haptic device. In case of tissue modelling, the constitutive matrix depends on the strain experienced by the element. In the present implementations, the strains can be used to construct the constitutive matrix (which is not possible in traditional XPBD framework). In the present examples, in case of injecting a needle, the tool or user device has a set of cylindrical colliders along its length. On interaction with the tissue, the collision detection algorithm finds out which of the triangle colliders on the tissue’s mesh interact with the cylindrical colliders of the tool’s mesh. The XPBD solver then resolves the positions of the particles so that the collision constraint is satisfied.

Human-computer interface (HCI) devices are used to convey intentions of human beings to computer systems via physical movements and/or gestures. Many HCI devices have capabilities to provide feedback about the interaction. However, computational load may limit the ability to provide real-time touch perception or force feedback. The improved modelling computation may reduce overall computational load and latency to allow real-time computation of interaction forces and global representation of interacting geometries in a virtual world. The interaction forces computed may be used to provide real-time haptic feedback for human computer interaction.

CAD tools are used in design for developing virtual representations of objects. In the design process, the designer interacts with the physical properties of the object such as the shape of the object, smoothness of the surface etc, as well as interactions between these objects. The improved modelling technique may be used to compute an interactive shape based on its interactively adjustable physical and material properties. The design inputs at one location of the shape can be used to compute the overall shape of the object. In one example, a designer may sculpt an object by performing a push and/or pull operation on the nodes of the virtual object. Propagation of deformation stresses and strains may be computed to model a physically realistic object with the design intent incorporated. The designer can interactively adjust the material properties of the object (or sub parts thereof) so that it behaves as a stiff material like steel or soft material like human tissue. In another example, a designer may design a part via a virtual forging process, where he/she moulds the shape of steel at various temperatures, by adjusting the material properties for these various temperatures.

CAD/E tools are used in engineering analysis and design. They involve the analysis of objects of various geometric shapes subject to forces and/or interactions with other objects. Given the geometric shapes and material properties, the improved modelling technique may be used to estimate the stresses and/or strains and/or deformations. The improved modelling technique may compute such stresses and/or strains and/or deformations in real time. This would allow for rapid iteration of designs coupled with analysis results.

In computer games and virtual reality simulations, most virtual objects and characters should realistically obey the laws of physics. Limits on computation tends to limit modelling to rigid, non-deformable interactions governed by rigid body dynamics. The improved modelling technique may allow computing the interactions of deformable bodies. The virtual objects can be modelled as deformable objects with physically accurate material properties.

### V. Combining Techniques From Other Modelling Frameworks

The systems and methods of the present disclosure provide constraint that bridges non-linear 3D elements of FEM with XPBD. The disclosed frame work defines a single constraint function that is derived from strain energy of the entire FEM element and works for any element type under consideration. The proposed constraint function incorporates FEM formulation into the XPBD framework. The constraint definition allows any FEM-element, linear and non-linear, to be integrated with the XPBD framework. For instance, the present constraint function definition works for both linear and nonlinear elements. This constraint definition enables the use of linear and non-linear tetrahedral elements. The examples provided here are for the linear and quadratic tetrahedron, but could be extended to any form of geometric elements. The present constraint formulation allows for, but not limited to, the following possibilities: continuous-curved element models; smoothly varying strains within an element; smoothly varying material properties within an element; simulation of materials with complex stress-strain relationships; framework to include empirical stress-strain relationships and the like.

The systems and methods of the present disclosure provide the ability to express the strain energy through this constraint. Extending this constraint to incorporate non-linear elements involves very minor changes to the formulation. With the ability to use non-linear elements, it enables larger range of solutions with fewer elements, thereby making the simulation efficient in terms of computing requirements. For non-linear and linear tetrahedron elements, the core method remains the same with XPBD framework, however the differences lie in the construction of the stiffness matrix used to compute the strain energy constraint required for position updates. Depending on whether a global method or a local stiffness method is used, the operations would be computationally cheap or utilize much less memory, respectively. For haptic rendering, any changes to the tissue’s behaviour as a result of its material properties can easily be done by tuning the Young’s modulus which is essentially a constant that can be tuned which is required in tissue or elastic body simulations. This makes this version of the constraint extremely flexible in terms of the ability to tune the simulation depending on the problem being solved. The solution to each FEM XPBD constraint can be computed on a single GPU thread. In comparison, XPBD would solve six strain expressions in separate threads. Since these strains act on the same nodes, this leads XPBD to update the same nodes from 6 different threads. As these 6 concurrent memory accesses to the same nodes' data which happens on a parallel processor, the memory accesses are forced to be serialized. The processing unit (such as, the CPU 205 and/or 305) may be a multi-thread processor, and wherein the deformation at the nodes of each of the geometric elements are computed in parallel, with each deformation being computer discretely at one of threads of the multi-thread processor. The FEM constraints described in invention are used within the XPBD framework where other constraints are solved in parallel and independently using GPUs. For example, herein, each tetrahedron is solved on a single thread on a GPU processor.

In the disclosed framework, the force is computed based on the gradient of the strain energy function which is calculated from the constraint itself. The strain energy represents how much energy gets stored in the tissue when subject to stretching. The force that is computed is the gradient of this energy which is fed back to the user, providing the user with an accurate force feedback from the tissue simulated. Another major advantage in the current approach is the reduction of the number of equations being solved from six to just one system using the constraint definition as described above. In XPBD each of the strains are modelled as individual constraints with the compliance matrix, consisting of the material constants. There are 6 strains that correspond to 6 different directions along which the strains occur, i.e.

$$ε = \left|\begin{matrix}{ε}_{z} \\ ε\end{matrix}\right|$$

Each of the above components of the strain vector together with the material matrix constitute individual constraints. An advantage here, is that all the strains and material properties are collected in a single constraint which is derived from the strain energy of the element, thus easing the implementation.

### VI. Embodiments

Embodiments may feature the following.

In general, in a first aspect, the invention features a method. In the memory of a computer is stored a model of an elastic body as a plurality of models of particles and models of geometric elements. Each particle model has a position attribute. Each geometric element has a boundary defined by two or more of the particles as nodes of the geometric element, nodes being points shared with neighbouring geometric elements. The computer models the interior area or volume of the geometric elements with non-linear interpolation functions that use the positions of the particles of the respective geometric elements as inputs to compute position and/or strain of interior points of the geometric elements. The processor computes an energy summed on the interior region of the element, the energy computation based on (a) position and/or stress of the geometric element computed by the non-linear interpolation functions and/or (b) non-linear material parameters that depend on position and/or strain at the interior points of the geometric elements. The processor computes new positions of the particles based on a computation to minimize total energy of the element.

Specific embodiments may incorporate one or more of the following features. A display of the modelled elastic body may be computed based on the computed new positions of the particles. A control value may be computed to be delivered to a haptic actuator of a physical apparatus instantiating the modelled elastic body, the computation based on the computed new positions of the particles and/or the stresses and/or the strains at the nodes and/or the interior points of one or more of geometric elements. The physical apparatus may be a medical simulator, robotic device, or human computer interaction (HCI) device. The elastic body may be an article under design or evaluation by a computer aided design (CAD) tool and/or computer aided design and/or engineering (CAD/E) tool. The elastic body is an article may be a game, virtual reality world, or animation world. Modelled objects may be displayed on a display in real time. The computation may balance kinetic energy introduced into a corresponding geometric element against potential energy contained within stresses among the plurality of particles in the geometric element. The energy computation may be based on position and/or bending of the geometric element computed by the non-linear interpolation functions. The energy computation may be based on non-linear material parameters that depend on position and/or strain at the interior points of the geometric elements. The energy computation may be based on both (a) position and/or bending of the geometric element computed by the non-linear interpolation functions, and (b) non-linear material parameters that depend on position and/or bending at the interior points of the geometric elements. Some of the geometric elements may be modelled by an energy computation based on linear interpolation functions for position and/or strain. Some of the geometric elements may be linear tetrahedra, some may be quadratic tetrahedral. Some may be cubic tetrahedra. Some of the geometric elements may be tetrahedra, some triangular prisms, and some hexahedra. The computation may be divided among cores of a processor for parallel computation.

An elastic body with a plurality of particles may be modeled by the following method. The elastic body is modeled as a plurality of geometric elements with one or more predefined geometries, each of the plurality of geometric elements having three or more particles among the plurality of particles as nodes for the one or more predefined geometries thereof. Each geometric element may have an associated constraint function indicative of strain energy for the element. A gradient of the constraint function may be computed to determine a direction of force on each of the geometric elements. A deformation at the nodes of each of the geometric elements along the determined direction of force is computed. The determined deformation at the nodes of each of the geometric elements to the respective entire geometric element is computed.

A system for real-time simulation of an elastic body may include a processor and a memory device coupled thereto. The memory device has instructions stored thereon that, in response to execution by the processing unit, cause the processing unit to perform operations. The elastic body is modelled as a plurality of geometric elements with one or more predefined geometries, each of the geometric elements having three or more particles among the plurality of particles as nodes for the one or more predefined geometries thereof. Each geometric element has one or more constraint functions indicative of strain energy. A gradient of the single constraint function is computed to determine a direction of force on each of the geometric elements. A deformation at the nodes of each of the geometric elements along the determined direction of force is computed. The determined deformation at the nodes of each of the geometric elements is interpolated to the respective entire geometric element.

The deformation at a given node of each of the geometric elements may be determined by defining a first position for a particle, among the plurality of particles, at the given node; computing a second position after a time step by resolving forces acting on the particle, among the plurality of particles, at the given node; and calculating the deformation for the particle, among the plurality of particles, at the given node as the difference between the first position and the second position thereof. Forces acting on the particle, among the plurality of particles, may be resolved at the given node by balancing kinetic energy introduced into a corresponding geometric element against potential energy contained within stresses among the plurality of particles in the geometric element. The geometric elements may be some combination of linear finite elements and non-linear finite elements, or all non-linear. Each of the geometric elements is in the shape of one of triangle, square, rectangle, cube, cuboid, tetrahedron and hexahedron. The single constraint function (Cⱼ(U)) for each of the geometric elements may be given by:

$${C}_{i} \left(U\right) = \sqrt{{U}^{T} {K}_{e} U} ,$$

wherein ‘U’ is the deformation at all nodes of a given element, and ‘Kₑ’ is the stiffness matrix computed over the corresponding entire geometric element and is given as:

$${K}_{e} = \sqrt{\int {B}^{T} Σ B d v} ,$$

wherein ‘B’ is the matrix that relates strains on the corresponding entire geometric element to the deformation at the given node and ∑ is the standard 6 × 6 constitutive matrix that relates deformation strains with stress forces. The gradient of the single constraint function (∇Cⱼ(U)) may be computed as:

$$∇ {C}_{j} \left(U\right) = \frac{{U}^{T} {K}_{e}}{{C}_{j}}$$

wherein ‘K’ is the stiffness matrix and is an integral that is computed over volume of the corresponding entire geometric element. The computation may be implemented in a haptic device for near real-time medical simulation. The processing unit may be a multi-thread processor. The deformation at the nodes of each of the geometric elements may be computed in parallel, with each deformation being computer discretely at one of threads of the multi-thread processor. A database may contain information about geometry of the elastic body. A sensor may be configured to detect and measure force of collision of an external object with the elastic body. The processing unit may be configured to define the single constraint function for each of the geometric elements of the elastic body based on the information about geometry of the elastic body and the said measured force. The memory may be further configured to store data generated for simulation of the elastic body to be used as one or more of for training a neural network and to be utilized by a neural network for enhancing simulation of elastic bodies.

The following are incorporated by reference. M. Muller, B. Heidelburger, M. Hennix and J. Ratcliff, “Position Based Dynamics,” Journal of Visual Communication and Image Representation (2007); M. Macklin, M. Muller and N. Chentanez, “XPBD: Position-Based Simulation of Compliant Constrained Dynamics,” SIGGRAPH: MIG '16: Proceedings of the 9th International Conference on Motion in Games (2016); D. R. Cook, D. S. Malkus, M. E. Plesha and R. J. Witt, Concepts and Applications of Finite Element Analysis, Wiley-India Edition, (2003-04); C. A. Felippa, Chapter 10, The Quadratic Tetrahedron, Colorado, Bolder; and S. Chakravarthy, A Haptic Simulator for Gastrointestinal Endoscopy : Design Development and Experiments, Indian Institute of Science, Bangalore, 2018; T. Karras, Maximizing Parallelism in the Construction of BVHs, High Performance Graphics (2012); M. Macklin, M. Mueller-Fischer and N. Chentanez, Strain Based Dynamics for Rendering Special Effects (2016).

### VII. Definitions and Computer Implementation

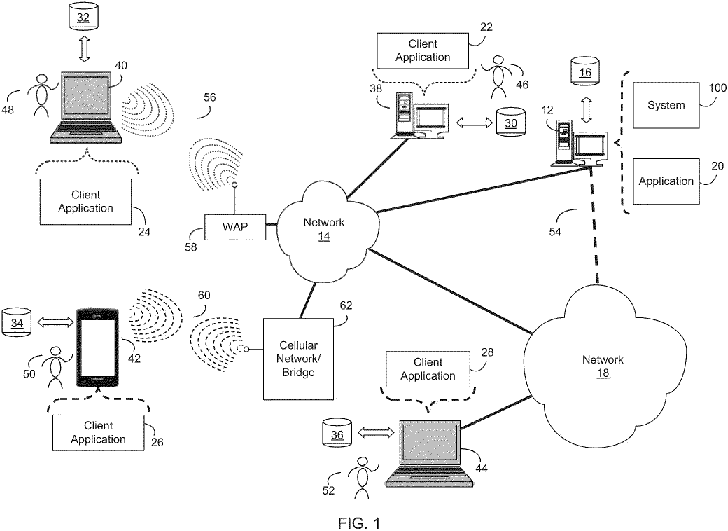

Referring now to the example implementation of FIG. 1, there is shown a system 100 that may reside on and may be executed by a computer (e.g., computer 12), which may be connected to a network (e.g., network 14) (e.g., the internet or a local area network). Examples of computer 12 may include, but are not limited to, a personal computer(s), a laptop computer(s), mobile computing device(s), a server computer, a series of server computers, a mainframe computer(s), or a computing cloud(s). In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, the instruction sets and subroutines of system 100, which may be stored on storage device, such as storage device 16, coupled to computer 12, may be executed by one or more processors (not shown) and one or more memory architectures included within computer 12. In some implementations, storage device 16 may include but is not limited to: a hard disk drive; a flash drive, a tape drive; an optical drive; a RAID array (or other array); a random access memory (RAM); and a read-only memory (ROM).

In some implementations, network 14 may be connected to one or more secondary networks (e.g., network 18), examples of which may include but are not limited to: a local area network; a wide area network; or an intranet, for example.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, system 100 may be a component of the data store, a standalone application that interfaces with the above noted data store and/or an applet / application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute application 20 for real-time simulation of an elastic body comprising a plurality of particles. In some implementations, system 100 and/or application 20 may be accessed via one or more of client applications 22, 24, 26, 28. In some implementations, system 100 may be a standalone application, or may be an applet / application / script / extension that may interact with and/or be executed within application 20, a component of application 20, and/or one or more of client applications 22, 24, 26, 28. In some implementations, application 20 may be a standalone application, or may be an applet / application / script / extension that may interact with and/or be executed within system 100, a component of system 100, and/or one or more of client applications 22, 24, 26, 28. In some implementations, one or more of client applications 22, 24, 26, 28 may be a standalone application, or may be an applet / application / script / extension that may interact with and/or be executed within and/or be a component of system 100 and/or application 20. Examples of client applications 22, 24, 26, 28 may include, but are not limited to, a standard and/or mobile web browser, an email application (e.g., an email client application), a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to user devices 38, 40, 42, 44, may be executed by one or more processors and one or more memory architectures incorporated into user devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM). Examples of user devices 38, 40, 42, 44 (and/or computer 12) may include, but are not limited to, a personal computer (e.g., user device 38), a laptop computer (e.g., user device 40), a smart/data-enabled, cellular phone (e.g., user device 42), a notebook computer (e.g., user device 44), a tablet (not shown), a server (not shown), a television (not shown), a smart television (not shown), a media (e.g., video, photo, etc.) capturing device (not shown), and a dedicated network device (not shown). User devices 38, 40, 42, 44 may each execute an operating system, examples of which may include but are not limited to, Android®, Apple® iOS®, Mac® OS X®; Red Hat® Linux®, or a custom operating system.

In some implementations, one or more of client applications 22, 24, 26, 28 may be configured to effectuate some or all of the functionality of system 100 (and vice versa). Accordingly, in some implementations, system 100 may be a purely server-side application, a purely client-side application, or a hybrid server-side / client-side application that is cooperatively executed by one or more of client applications 22, 24, 26, 28 and/or system 100.

In some implementations, one or more of client applications 22, 24, 26, 28 may be configured to effectuate some or all of the functionality of application 20 (and vice versa). Accordingly, in some implementations, application 20 may be a purely server-side application, a purely client-side application, or a hybrid server-side / client-side application that is cooperatively executed by one or more of client applications 22, 24, 26, 28 and/or application 20. As one or more of client applications 22, 24, 26, 28, system 100, and application 20, taken singly or in any combination, may effectuate some or all of the same functionality, any description of effectuating such functionality via one or more of client applications 22, 24, 26, 28, system 100, application 20, or combination thereof, and any described interaction(s) between one or more of client applications 22, 24, 26, 28, system 100, application 20, or combination thereof to effectuate such functionality, should be taken as an example only and not to limit the scope of the disclosure.

In some implementations, one or more of users 46, 48, 50, 52 may access computer 12 and system 100 (e.g., using one or more of user devices 38, 40, 42, 44) directly through network 14 or through secondary network 18. Further, computer 12 may be connected to network 14 through secondary network 18, as illustrated with phantom link line 54. System 100 may include one or more user interfaces, such as browsers and textual or graphical user interfaces, through which users 46, 48, 50, 52 may access system 100.

In some implementations, the various user devices may be directly or indirectly coupled to network 14 (or network 18). For example, user device 38 is shown directly coupled to network 14 via a hardwired network connection. Further, user device 44 is shown directly coupled to network 18 via a hardwired network connection. User device 40 is shown wirelessly coupled to network 14 via wireless communication channel 56 established between user device 40 and wireless access point (i.e., WAP) 58, which is shown directly coupled to network 14. WAP 58 may be, for example, an IEEE 802.11a, 802.11b, 802.11 g, Wi-Fi®, RFID, and/or Bluetooth™ (including Bluetooth™ Low Energy) device that is capable of establishing wireless communication channel 56 between user device 40 and WAP 58. User device 42 is shown wirelessly coupled to network 14 via wireless communication channel 60 established between user device 42 and cellular network / bridge 62, which is shown directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example, Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

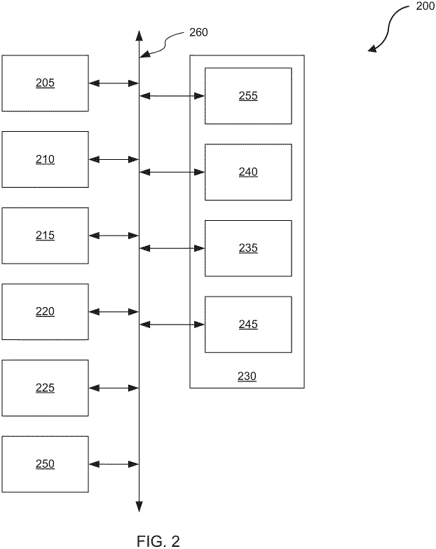

The system 100 may include a computing system 200 (in the form of a server device 200, as shown in FIG. 2) to handle intensive processing for real-time simulation of the elastic body. Herein, FIG. 2 is a block diagram of an example of the server device 200 capable of implementing embodiments according to the present invention. In one embodiment, an application server as described herein may be implemented on exemplary server device 200. In the example of FIG. 2, the server device 200 includes a processing unit 205 (hereinafter, referred to as CPU 205) for running software applications (such as, the application 20 of FIG. 1) and optionally an operating system. Memory 210 stores applications and data for use by the CPU 205. Storage 215 provides non-volatile storage for applications and data and may include fixed disk drives, removable disk drives, flash memory devices, and CD-ROM, DVD-ROM or other optical storage devices. An optional user input device 220 includes devices that communicate user inputs from one or more users to the server device 200 and may include keyboards, mice, joysticks, touch screens, etc. A communication or network interface 225 is provided which allows the server device 200 to communicate with other computer systems via an electronic communications network, including wired and/or wireless communication and including an Intranet or the Internet. In one embodiment, the server device 200 receives instructions and user inputs from a remote computer through communication interface 225. Communication interface 225 can comprise a transmitter and receiver for communicating with remote devices. An optional display device 250 may be provided which can be any device capable of displaying visual information in response to a signal from the server device 200. The components of the server device 200, including the CPU 205, memory 210, data storage 215, user input devices 220, communication interface 225, and the display device 250, may be coupled via one or more data buses 260.

In the embodiment of FIG. 2, a graphics system 230 may be coupled with the data bus 260 and the components of the server device 200. The graphics system 230 may include a physical graphics processing unit (GPU) 235 and graphics memory. The GPU 235 generates pixel data for output images from rendering commands. The physical GPU 235 can be configured as multiple virtual GPUs that may be used in parallel (concurrently) by a number of applications or processes executing in parallel. For example, mass scaling processes for rigid bodies or a variety of constraint solving processes may be run in parallel on the multiple virtual GPUs. Graphics memory may include a display memory 240 (e.g., a framebuffer) used for storing pixel data for each pixel of an output image. In another embodiment, the display memory 240 and/or additional memory 245 may be part of the memory 210 and may be shared with the CPU 205. Alternatively, the display memory 240 and/or additional memory 245 can be one or more separate memories provided for the exclusive use of the graphics system 230. In another embodiment, graphics processing system 230 includes one or more additional physical GPUs 255, similar to the GPU 235. Each additional GPU 255 may be adapted to operate in parallel with the GPU 235. Each additional GPU 255 generates pixel data for output images from rendering commands. Each additional physical GPU 255 can be configured as multiple virtual GPUs that may be used in parallel (concurrently) by a number of applications or processes executing in parallel, e.g. processes that solve constraints. Each additional GPU 255 can operate in conjunction with the GPU 235, for example, to simultaneously generate pixel data for different portions of an output image, or to simultaneously generate pixel data for different output images. Each additional GPU 255 can be located on the same circuit board as the GPU 235, sharing a connection with the GPU 235 to the data bus 260, or each additional GPU 255 can be located on another circuit board separately coupled with the data bus 260. Each additional GPU 255 can also be integrated into the same module or chip package as the GPU 235. Each additional GPU 255 can have additional memory, similar to the display memory 240 and additional memory 245, or can share the memories 240 and 245 with the GPU 235. The circuits and/or functionality of GPU as described herein could also be implemented in other types of processors, such as general-purpose or other special-purpose coprocessors, or within a CPU.

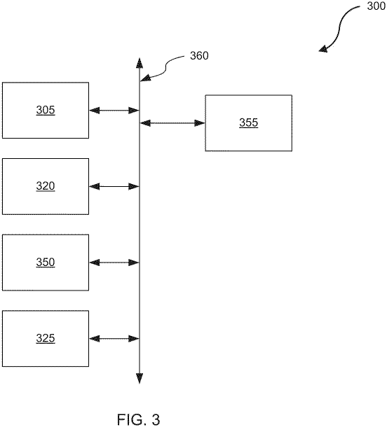

The system 100 may also include an end user or a client device 300 (as shown in FIG. 3). Herein, FIG. 3 is a block diagram of an example of the client device 300 capable of implementing embodiments according to the present invention. In the example of FIG. 3, the client device 300 includes a processing unit 305 (hereinafter, referred to as CPU 305) for running software applications (such as, the application 20 of FIG. 1) and optionally an operating system. A user input device 320 is provided with includes devices that communicate user inputs from one or more users and may include keyboards, mice, joysticks, touch screens, and/or microphones. Further, a communication interface 325 is provided which allows the client device 300 to communicate with other computer systems (e.g., the computing system 200 of FIG. 2) via an electronic communications network, including wired and/or wireless communication and including the Internet. The client device 300 may also include a decoder 355 may be any device capable of decoding (decompressing) data that may be encoded (compressed). For example, the decoder 355 may be an H.264 decoder. A display device 350 may be provided which may be any device capable of displaying visual information, including information received from the decoder 355. In particular, as will be described below, the display device 350 may be used to display visual information received from the server device 200 of FIG. 2. The components of the client device 300 may be coupled via one or more data buses 360.

It may be seen that compared to the server device 200 in the example of FIG. 2, the client device 300 in the example of FIG. 3 may have fewer components and less functionality and, as such, may be referred to as a user device or the like. However, the client device 300 may include other components including those described above. In general, the client device 300 may be any type of device that has display capability, the capability to decode (decompress) data, and the capability to receive inputs from a user and send such inputs to the computing system 200. However, the client device 300 may have additional capabilities beyond those just mentioned. The client device 300 may be, for example, a personal computer, a tablet computer, a mobile device, a gaming console, a television, or the like.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments.

Furthermore, in the following detailed description of the present disclosure, numerous specific details are set forth in order to provide a thorough understanding of the present disclosure. However, the present disclosure may be practiced without these specific details. In other instances, well-known methods, procedures, components, and circuits have not been described in detail so as not to unnecessarily obscure aspects of the present disclosure.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Some portions of the detailed description that follows are presented and discussed in terms of a process or method. Although steps and sequencing thereof are disclosed in figures herein describing the operations of this method, such steps and sequencing are exemplary. Embodiments are well suited to performing various other steps or variations of the steps recited in the flowchart of the figure herein, and in a sequence other than that depicted and described herein. Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fibre, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fibre cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. In present implementations, the used language for training may be one of Python, Tensorflow™, Bazel, C, C++. Further, decoder in user device (as will be discussed) may use C, C++ or any processor specific ISA. Furthermore, assembly code inside C/C++ may be utilized for specific operation. Also, ASR (automatic speech recognition) and G2P decoder along with entire user system can be run in embedded Linux (any distribution), Android, iOS, Windows, or the like, without any limitations. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. In some implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

Various processes described herein may be implemented by appropriately programmed general purpose computers, special purpose computers, and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in one or more computer programs, one or more scripts, or in other forms. The processing may be performed on one or more microprocessors, central processing units (CPUs), computing devices, microcontrollers, digital signal processors, or like devices or any combination thereof. Programs that implement the processing, and the data operated on, may be stored and transmitted using a variety of media. In some cases, hardwired circuitry or custom hardware may be used in place of, or in combination with, some or all of the software instructions that can implement the processes. Algorithms other than those described may be used.

Programs and data may be stored in various media appropriate to the purpose, or a combination of heterogeneous media that may be read and/or written by a computer, a processor or a like device. The media may include non-volatile media, volatile media, optical or magnetic media, dynamic random access memory (DRAM), static ram, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge or other memory technologies. Transmission media include coaxial cables, copper wire and fiber optics, including the wires that comprise a system bus coupled to the processor.

Databases may be implemented using database management systems or ad hoc memory organization schemes. Alternative database structures to those described may be readily employed. Databases may be stored locally or remotely from a device which accesses data in such a database.

In some cases, the processing may be performed in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

A server computer or centralized authority may or may not be necessary or desirable. In various cases, the network may or may not include a central authority device. Various processing functions may be performed on a central authority server, one of several distributed servers, or other distributed devices

For clarity of explanation, the above description has focused on a representative sample of all possible embodiments, a sample that teaches the principles of the invention and conveys the best mode contemplated for carrying it out. The invention is not limited to the described embodiments. Well known features may not have been described in detail to avoid unnecessarily obscuring the principles relevant to the claimed invention. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed alternatives, variations, modifications, and equivalents are within the literal scope of the following claims, and others are equivalent. The claims may be practiced without some or all of the specific details described in the specification. In many cases, method steps described in this specification can be performed in different orders than that presented in this specification, or in parallel rather than sequentially, or in different computers of a computer network, rather than all on a single computer.

As discussed, the systems and methods of the present disclosure solves elastic interactions in real-time. The framework is more efficient and particularly useful for virtual interactions in the field of Virtual Reality and Mixed Reality. More importantly, the framework also supports haptics interactions that are challenging due to high computation requirement. The present disclosure enables realistic simulation of deformations of elastic bodies such as human tissues and tool tissue interactions. These simulations are also extendible to situations where it is useful to study the real time effects of arbitrary loads on bodies, example, effect of large varying seismic loads on long steel columns.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

The invention claimed is:

1. A method comprising the steps of:
in the memory of a computer, storing a model of an elastic body as (a) a plurality of models of particles, each particle model having a position attribute, and (b) a plurality of models of geometric elements, the geometric elements forming an exhaustive and mutually exclusive partition of the elastic body, each geometric element having a boundary defined at least in part by two or more of the particles as nodes of the geometric element, nodes being particles shared with neighbouring geometric elements;
in the computer, modelling the interior area or volume of the geometric elements with non-linear interpolation functions that use the positions of the particles of the respective geometric elements as inputs to compute position and/or strain of interior points of the geometric elements;
in a processor of the computer, computing an energy summed on the interior region of the element, the energy computation based on (a) position and/or stress of the geometric element computed by the non-linear interpolation functions and/or (b) non-linear material parameters that depend on position and/or strain at the interior points of the geometric elements; and
in a processor of the computer, computing new positions of the particles based on a computation to minimize total energy of the element.

2. The method of claim 1, further comprising the step of:
computing a display of the modeled elastic body based on the computed new positions of the particles.

3. The method of claim 1, further comprising the step of:
computing a control value to be delivered to a haptic actuator of a physical apparatus instantiating the modeled elastic body, the computation based on the computed new positions of the particles and/or the stresses and/or the strains at the nodes and/or the interior points of one or more of geometric elements.

4. The method of claim 3, wherein:
the physical apparatus is a medical simulator.

5. The method of claim 3, wherein;
the physical apparatus is a robotic device.

6. The method of claim 3 wherein;
the physical apparatus is a human computer interaction (HCI) device.

7. The method of claim 1:
wherein the elastic body is an article under design or evaluation by a computer aided design (CAD) tool and/or computer aided design and/or engineering (CAD/E) tool, and further comprising the step of displaying modelled objects on a display in real time.

8. The method of claim 1:
wherein the elastic body may be an article or character in a game, virtual reality world, or animation world, and
further comprising the step of displaying modelled objects on a display in real time.

9. The method of claim 1, further comprising:
balancing kinetic energy introduced into a corresponding geometric element against potential energy contained within stresses among the plurality of particles in the geometric element.

10. The method of claim 1, wherein:
the energy computation is based on position and/or bending of the geometric element computed by the non-linear interpolation functions.

11. The method of claim 1, wherein:
the energy computation is based on non-linear material parameters that depend on position and/or strain at the interior points of the geometric elements.

12. The method of claim 1, wherein:
the energy computation based on both (a) position and/or bending of the geometric element computed by the non-linear interpolation functions, and (b) non-linear material parameters that depend on position and/or bending at the interior points of the geometric elements.

13. The method of claim 1, wherein:
some of the geometric elements are modeled by an energy computation based on linear interpolation functions for position and/or strain.

14. The method of claim 1, wherein:
some of the geometric elements are linear tetrahedra, some are quadratic tetrahedra, and some are cubic tetrahedra.

15. The method of claim 1, wherein:
some of the geometric elements are tetrahedra, and some are triangular prisms, and some are hexahedra.

16. The method of claim 1, further comprising the step of:
dividing the computation among cores of a processor for parallel computation.

17. An apparatus, comprising:
a computer having a memory and a processor;
in the memory one or more programs programmed to cause the computer to:
store in the memory a model of an elastic body as (a) a plurality of models of particles, each particle model having a position attribute, and (b) a plurality of models of geometric elements, the geometric elements forming an exhaustive and mutually exclusive partition of the elastic body, each geometric element having a boundary defined at least in part by two or more of the particles as nodes of the geometric element, nodes being particles shared with neighbouring geometric elements;
in the processor, compute a model of the interior area or volume of the geometric elements with non-linear interpolation functions that use the positions of the particles of the respective geometric elements as inputs to compute position and/or strain of interior points of the geometric elements;
in the processor of the computer, compute an energy summed on the interior region of the element, the energy computation based on (a) position and/or stress of the geometric element computed by the non-linear interpolation functions and/or (b) non-linear material parameters that depend on position and/or strain at the interior points of the geometric elements; and
in the processor, compute new positions of the particles based on a computation to minimize total energy of the element.
